(19) United States
(12) Patent Application Publication
(10) Pub. No.: US 2026/0340321 A1
(43) Pub. Date: Oct. 29, 2026

(54) CIRCUIT, SYSTEM AND METHOD FOR IN-TRANSIT MASSIVELY PARALLEL MATRIX MULTIPLICATION VIA CAPACITANCE-BASED COMPUTATION

(71) Applicant: The University of Hong Kong, Hong Kong (HK)

(72) Inventors: Song WANG, Hong Kong (HK); Zhu WANG, Hong Kong (HK); Kwok Hay Hayden SO, Hong Kong (HK); Can LI, Hong Kong (HK)

(21) Appl. No.: 19/660,234

(22) Filed: Apr. 28, 2026

Related U.S. Application Data
(60) Provisional application No. 63/797,049, filed on Apr. 29, 2025.

(51) Int. Cl. G06G 7/32

(52) U.S. Cl. CPC G06G 7/32

(57) ABSTRACT

A method for in-transit massively parallel matrix multiplication (A*B) via capacitance-based computation is provided, including: generating a sequence of analog spike signals by applying an amplitude-temporal dual encoding scheme, wherein spike amplitudes represent matrix A row elements and spike timings represent matrix B column elements; applying the analog spike signals to analog computing cores; accumulating and discharging charge in a capacitor of each of the analog computing cores in response to the analog spike signals, thereby producing a time-varying voltage corresponding to a dot product result; detecting a time interval required for the voltage of the capacitor to return to an equilibrium level; and decoding the time interval into a digital result using a time-based decoding scheme, wherein the decoding is based on the number of clock cycles elapsed during the capacitor voltage's convergence to an equilibrium level.

### TECHNICAL FIELD

The present invention generally relates to hardware acceleration for artificial intelligence (AI). More specifically, the present invention relates to a mixed-signal capacitive computing-in-memory architecture for parallel in-transit matrix multiplication using amplitude-temporal encoding and time-based decoding.

### BACKGROUND

The rapid growth of artificial intelligence has intensified demand for energy-efficient hardware accelerators, given the computational challenges posed by deep learning algorithms and limitations of conventional von Neumann architectures. Although digital accelerators have evolved through specialized processing elements and dataflow optimizations, they still face inherent constraints such as high data movement costs and CMOS scaling limits. Analog computing-in-memory (CIM) solutions, using emerging non-volatile devices such as memristors, memcapacitors, and phase-change memory (PCM) devices, promise greater energy efficiency by performing computations directly within memory arrays. However, these analog approaches suffer from device non-idealities, such as conductance drift and stochasticity, peripheral circuit overhead, particularly power-hungry analog-to-digital converters (ADCs), and IR drop.

Therefore, there is a need for a capacitive computing accelerator that leverages passive charge dynamics to perform low-power, high-throughput matrix computations with reduced reliance on analog-to-digital conversion.

### SUMMARY OF INVENTION

An objective of the present invention is to address the aforementioned technical problems.

In the present invention, a matrix multiplication accelerator based on capacitive computing, named WireLightning, is introduced. WireLightning is a mixed-signal architecture that exploits the intrinsic charge dynamics of capacitors for analog acceleration. Unlike analog crossbars that encode weights in programmable devices, matrix elements are represented through precisely timed spike amplitudes, and passive capacitors' charge buildup and predictable decay are leveraged for analog multiply-accumulate (MAC) operations. This architecture addresses two critical challenges of existing analog accelerators:
(1) Device Non-Idealities: By encoding weights transiently in spike timing rather than persistent device states, weight drift and stochastic switching are reduced, with a range-normalized RMSE and normalized error reduced to 69.2% and 77.1% of memristor-based and PCM-based accelerators, respectively.
(2) ADC Bottlenecks: A time-based decoding scheme replaces traditional power-intensive ADCs with efficient clock-driven threshold detection, reducing ADC energy by 98.8% and 99.9% compared to other architectures.

In the present invention, key innovations include amplitude-temporal dual encoding. The amplitude-temporal dual encoding achieves constant-time dot products via capacitor charge dynamics. The present invention further provides row-parallel passive computing using a scalable capacitor array. The scalable capacitor array concurrently processes each matrix row on a dedicated core and realizes simultaneous dot-product calculations for enhanced throughput. The present invention further provides common value reuse in low-bit quantized vectors. The common value reuse reduces multiplication complexity independent of matrix size while minimizing spike counts and computational errors.

Past works have established matrix-vector multiplication (MVM) computations using devices such as memristors, memcapacitors, and PCM devices, whereas the present invention implements MVM using standard CMOS capacitors with circuit techniques suitable for practical deployment. Implemented in a 40-nm CMOS technology node, WireLightning achieves 465.47 TOPS/W at 4-bit precision, with more than a 2.9-fold improvement in power efficiency over analog crossbar-array accelerators under equivalent precisions. Despite the precision limitations inherent in analog computing, the prototype demonstrates a range-normalized RMSE of 1.80% and a normalized error of 9.18% in PCB experiments. By integrating capacitive computing with circuit-level co-design, WireLightning demonstrates that capacitive computation provides a practical approach for energy-efficient edge AI applications.

In accordance with a first aspect of the present invention, a method for in-transit massively parallel matrix multiplication via capacitance-based computation is provided. Capacitors, with their inherent ability to accumulate charge and predictable discharge behavior, present a solution for performing matrix multiplication. Leveraging the charge buildup during charging to represent accumulation and its predictable decay during discharging to represent multiplication, a capacitor can implement the dot product of vectors, which is the core operation of MVM operations. The method of MVM include steps as follows: generating a sequence of analog spike signals by applying an amplitude-temporal dual encoding scheme, wherein spike amplitudes represent matrix row elements and spike timings represent matrix column elements; applying the analog spike signals to a plurality of analog computing cores; accumulating and discharging charge in a capacitor of each of the analog computing cores in response to the analog spike signals, thereby producing a time-varying voltage corresponding to a dot product result; detecting, using a comparator circuit, a time interval required for the time-varying voltage of the capacitor to return to an equilibrium level; and decoding the time interval into a digital result using a time-based decoding scheme, wherein the decoding is based on the number of clock cycles elapsed during the capacitor voltage's convergence to an equilibrium level.

In accordance with a second aspect of the present invention, a computing core circuit for dot product of vectors is provided. The core circuit comprises three components: a DAC, a capacitor (CAP), and a comparator circuit (COMP). The DAC is implemented by an R-2R ladder DAC that regulates capacitor charging and discharging by generating analog spike sequences. The capacitor voltage begins decaying toward equilibrium when the DAC output equals half of source voltage, V_{DD}/2. DAC output above V_{DD}/2 causes rapid capacitor charging followed by a gradual discharge back to equilibrium once the DAC output returns to V_{DD}/2; DAC output below V_{DD}/2 causes rapid discharging and slow recharging to equilibrium upon restoration to V_{DD}/2. The grounded capacitor (CAP) is positioned between the DAC output and the COMP input, serving as the primary component for vector multiplication. Since the COMP input is directly connected to transistor gates, the DAC exclusively controls the charge injection and release of the capacitor. This design minimizes the charge leakage, and thus preserves computational accuracy and signal integrity. The comparator circuit (COMP) comprises two distinct paths: a positive-result path (OUTP) containing the even number of inverters, and a negative-result path (OUTN) with the odd number of inverters. OUTP outputs logical 1 when capacitor voltage is above equilibrium (V_{DD}/2); OUTN outputs logical 1 when capacitor voltage is below equilibrium. Voltage deviations from equilibrium are thus converted into digital signals. Increased capacitor voltage on the positive path or decreased voltage on the negative path extends the duration of high-level outputs. Consequently, the analog results are decoded into digital values based on the clock cycles required for the capacitor voltage to return to equilibrium. In summary, the computing core completes vector multiplication once all spike signals have been transmitted to the capacitor and computational results have been decoded by measuring clock cycles needed for the capacitor voltage to stabilize back to equilibrium. This method integrates analog-to-digital conversion within the capacitor reset process, removing the need for traditional high-power, large-area ADCs and enhancing scalability.

In accordance with a third aspect of the present invention, a system for in-transit massively parallel matrix multiplication (A*B) via capacitance-based computation is provided. The system includes a controller, a plurality of analog computing cores, a reader, and a scheduler. The controller is configured to: generate a sequence of analog spike signals based on matrix data using an amplitude-temporal dual encoding scheme, wherein spike amplitudes correspond to matrix A row elements and spike timings correspond to matrix B column elements; and to simplify matrix A columns by identifying repeated absolute values in a quantized column vector of matrix B, grouping corresponding elements in matrix A, and pre-accumulating the grouped values to reduce a number of multiplications to a constant count. The analog computing cores receive the analog spike signals from the controller, in which each analog computing core includes a resistor-ladder digital-to-analog converter (DAC), a capacitor, and a comparator circuit. The resistor-ladder DAC is configured to receive the analog spike signals from the controller and convert them into voltage pulses. The capacitor is electrically coupled to the resistor-ladder DAC and is configured to accumulate and discharge charge in response to the voltage pulses, thereby generating a time-varying voltage that represents an analog result of a dot product operation. The comparator circuit is electrically coupled to the capacitor and configured to monitor a voltage of the capacitor, detect a deviation from an equilibrium level, and generate a signal indicating a time interval required for the voltage to return to the equilibrium level. The reader is electrically coupled to each comparator circuit and is configured to determine a digital result of the dot product operation by measuring the time interval and converting the time interval into a quantized value using a time-based decoding scheme. The scheduler is configured to coordinate data transfers and timing control among the controller, the analog computing cores, and the reader during matrix-vector multiplication. The analog computing cores are arranged in a row-wise parallel architecture, and each of the analog computing cores is configured to compute a dot product between one matrix A row and a column vector of matrix B concurrently and independently.

### BRIEF DESCRIPTION OF DRAWINGS

Embodiments of the present invention are described in more details hereinafter with reference to the drawings, in which:

FIG. 1 shows an operational principle of capacitive computation for a dot product of two vectors;

FIG. 2 shows an amplitude-temporal dual encoding scheme;

FIG. 3 shows a time-based decoding scheme;

FIG. 4 shows row-parallel computation on matrix A according to some embodiments of the present invention, in which each row of A is concurrently multiplied with the column vector b from matrix B;

FIG. 5 shows multiplication simplification by exploiting repeated absolute values in columns of matrix B to group corresponding columns of matrix A;

FIG. 6 shows an overall system architecture of WireLightning, comprising eight tiles interconnected with a memory controller according to some embodiments of the present invention;

FIG. 7 shows a schematic diagram of the analog computing core, comprising a resistor-ladder DAC, a capacitor (CAP), and greater-than and less-than comparators (COMP) according to some embodiments of the present invention;

FIG. 8 shows responses of the analog computing core, including capacitor voltage, greater-than comparator output (OUTP), and less-than comparator output (OUTN), in response to the digital signals (I (3:0));

FIG. 9 shows positive and negative spike generation based on register values;

FIG. 10 shows a workflow of WireLightning, illustrating pipelined processing stages including loading a vector, simplifying a matrix, generating spikes, and decoding a result;

FIG. 11 shows a schematic experimental setup for PCB-level validation with parts (a) and (b), in which part (a) schematically shows a host computer, a controller FPGA board, a test board hosting analog computing cores, a power supply, and an oscilloscope, and part (b) schematically shows the test board including a plurality of computing cores, each computing core including a resistor-ladder DAC, a capacitor, and greater-than and less-than comparators;

FIG. 12 shows oscilloscope waveforms illustrating capacitor voltage and comparator outputs with parts (a) and (b), wherein part (a) shows a positive calculation result and part (b) shows a negative calculation result, and in each of parts (a) and (b), a first trace (A) represents capacitor voltage, a second trace (B) represents a comparator output (positive/negative result-path), a third trace (C) represents a decode-result start signal, and a fourth trace (D) represents a completion signal;

FIG. 13 shows frequency distribution of 560,000 vector multiplication results from PCB experiments;

FIG. 14 shows chip simulation results from Virtuoso that illustrate the operation of WireLightning and the resulting capacitor voltages across the computing cores;

FIG. 15 shows chip layout at different hierarchical levels with parts (a), (b), (c), and (d), wherein part (a) shows an overall architecture, part (b) shows a tile, part (c) shows a computation engine, and part (d) shows a computing core, having dimensions of 5920.31 μm×2166.81 μm, 1469.08 μm×1071.40 μm, 146.34 μm×929.06 μm, and 45.22 μm×33.16 μm, respectively;

FIG. 16 shows single vector multiplication in the analog computing core;

FIG. 17 shows a table for comparing the architecture of the present invention with state-of-the-art designs in throughput, area efficiency, and power efficiency;

FIG. 18 shows a block diagram of a capacitance-based matrix multiplication system according to some embodiments of the present invention; and

FIG. 19 shows a block diagram of an analog computing core according to some embodiments of the present invention.

### DETAILED DESCRIPTION OF THE INVENTION

In the following description, apparatuses, systems, and/or methods for in-transit massively parallel matrix multiplication via capacitance-based computation and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

To facilitate a clear understanding of the present disclosure, the following section provides background information on AI accelerators.

### I: Background of AI Accelerator

### A. Digital Accelerators

Digital accelerator designs have evolved significantly to enhance performance and resource utilization. Early designs, optimized primarily for dense models, became inefficient with sparse models due to redundant computations on zero operands. Although weight-oriented dataflow approaches addressed sparsity, such approaches introduced load imbalances, causing idle processing cycles. One related work mitigated load imbalance by introducing a weight reordering algorithm and a hybrid parallel dataflow, but increased memory overhead for storing nonzero weight positions. Another related work incorporated mixed-precision computing via a memory-adaptive pruning and quantization algorithm, thereby improving processing element utilization and addressing memory constraints. However, reliance on neural architecture search increased computational overhead.

Digital accelerator designs have progressed from sparsity-focused approaches to more sophisticated architectures incorporating adaptive dataflow, load balancing, and mixed-precision techniques. Nonetheless, data movement and memory access remain critical factors affecting power efficiency. Since maximizing data reuse and minimizing memory access are important for achieving system-level efficiency, alternative approaches have been explored. In this context, analog accelerators, leveraging analog computing, in-memory processing, and mixed-signal techniques, provide a path toward enhanced power efficiency.

### B. Analog Crossbar-Array Accelerators

Analog crossbar-array accelerators, whether based on memristors, PCM, or memcapacitors, perform in-situ MVM operations, thereby reducing data movement and computational costs compared to digital architectures. Early designs use resistive random-access memory (RRAM) and PCM crossbars to execute parallel dot-product operations by leveraging Ohm's Law for multiplication at each cross point and Kirchhoff's Law for current summation at each column. However, such initial designs lack comprehensive support for complex neural networks such as CNNs. Later advancements introduce in-situ CNN processing, pipeline execution, flexible memory configurations, and general-purpose units for diverse inference workloads. More recent PCM-based architectures achieve scaled integration, as demonstrated by a 64-core mixed-signal chip that supports high-throughput CNN and LSTM inference with minimal off-chip interaction. A subsequent PCM study implements 4-quadrant analog multiplication and conductance calibration to improve accuracy and operation.

Memcapacitor-based accelerators encode weights as capacitances and perform MVM via voltage multiplication and charge accumulation. Early work highlights energy efficiency, non-volatility, and scalability at both device and array levels, but overlooks circuit-level details for practical system implementation. Subsequent research addresses this gap by demonstrating a ferroelectric capacitive array-based computing-in-memory macro with optimized analog multiply-accumulate circuits.

Although analog accelerators have advantages in computational parallelism and energy efficiency, such accelerators face limitations such as weight drift from material instabilities, polarization fatigue, and programming non-idealities. In the present invention, inputs and weights are encoded as controlled spike signals rather than being directly stored in programmable cells. This signal-based approach eliminates device-state programming and mitigates weight drift and stochastic behaviors, while utilizing intrinsic charge dynamics of passive capacitors for massively parallel computation, minimizing energy overhead, and improving MVM accuracy. Furthermore, an op-amp-free ADC improves energy efficiency compared to existing analog crossbar-array accelerators.

The following sections describe theoretical principles, operational configurations, and validation relating to capacitive computation in accordance with the present invention. Based on such principles, configurations, and validation, the present invention further provides specific hardware architectures, circuit arrangements, and system implementations for performing matrix multiplication. The translation of such theoretical and operational content into physical hardware components and coordinated hardware structures constitutes one technical contribution of the present invention.

### II: Principle of Capacitive Computation

### A. Theoretical Framework

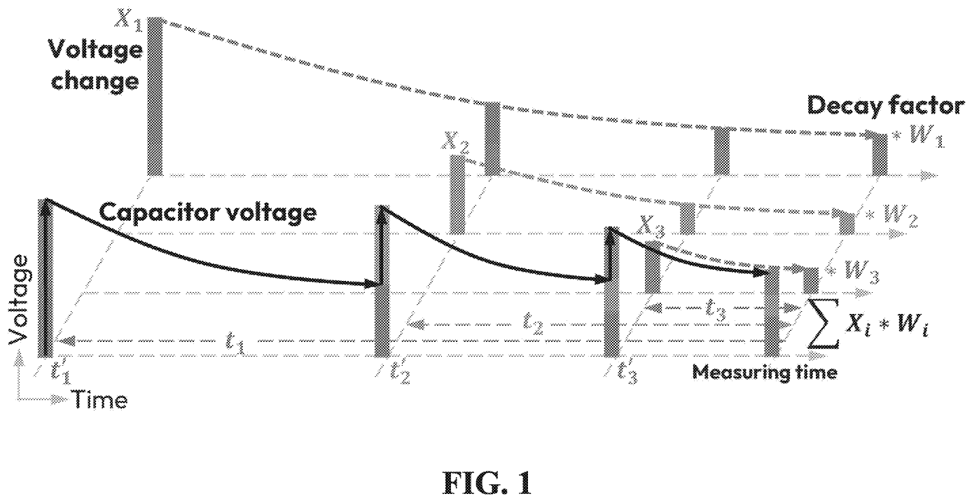

Matrix multiplication fundamentally involves two operations: multiplication and accumulation. Capacitors, with their inherent ability to accumulate charge and predictable discharge behavior, present an intriguing method for performing matrix multiplication. Leveraging the charge buildup during charging to represent accumulation and its predictable decay during dis-charging to represent multiplication, capacitors can potentially implement the core operations of MVM operations, as shown in FIG. 1.

FIG. 1 shows operational principle of capacitive computation for the dot product of two vectors. The immediate capacitor voltage changes induced by input spikes occurring at discrete times

$${t}_{1}^{′} , {t}_{2}^{′} , and {t}_{3}^{′}$$

are denoted as X₁, X₂, and X₃, respectively. After respective decay intervals t₁, t₂, and t₃, these initial voltage changes decay to X₁*W₁, X₂*W₂, and X₃*W₃, scaled by their corresponding decay factors Wᵢ. At the designated measurement time, the accumulated capacitor voltage corresponds to the sum of these decayed voltages. Therefore, sequential application of spikes at discrete time points to the capacitor allows the resulting measured voltage to represent the dot product between the vector of immediate voltage changes after each spike and the vector of decay factors at the measurement time.

Assuming an initially uncharged capacitor and a sequence of discrete, brief charging spikes, the voltage across a capacitor at a given time is characterized by:

$${V}_{t} = \sum \frac{{y}_{i} \cdot {T}_{w}}{τ} \cdot {e}^{\frac{- {t}_{i}}{τ}} = \sum {X}_{i} {W}_{i} \qquad ( 1 )$$

Where Xᵢ equals

$$\frac{{y}_{i} \cdot {T}_{ω}}{τ}$$

and Wᵢ equals

$${e}^{\frac{- {t}_{i}}{τ}} . {V}_{t}$$

represents the instantaneous capacitor voltage, yᵢ represents the amplitude of the i-th spike, T_{ω} represents the temporal width of spikes, yᵢ·T_{ω} represents the area under the i-th spike, tᵢ represents the elapsed decay time since the i-th spike, t represents the time constant of the capacitor circuit (the product of capacitance and resistance), X represents the instantaneous voltage change across the capacitor immediately after the i-th spike, and Wᵢ represents the decay factor of the i-th spike. According to Eq. 1, by sequentially applying a series of amplitude-modulated spikes to the capacitor at discrete times, the capacitor's resulting voltage represents the dot product of two vectors. Thus, the voltage across a capacitor after these spikes effectively encodes the inner product of the vector X represented by spike amplitudes, and the vector W represented by their time-dependent decay. Practically, vector multiplication can be realized by encoding one vector in spike amplitudes and the other inspike timing. Upon receiving the spike sequence, the capacitor naturally integrates the incoming signals, resulting in a voltage that directly represents the vector inner product. Since this computation occurs simultaneously with spike transmission, this approach is referred to herein as “in-transit computation.”

### B. Encoding Elements and Decoding Results

Matrix multiplication of matrices A and B is physically implemented by encoding their elements into discrete spike characteristics. Specifically, elements of matrix A, aᵢ, are encoded into spike amplitudes yᵢ, according to Eq. 2. This amplitude encoding is achieved through discrete levels of the supply voltage, V_{DD}, with N₁ representing the number of amplitude levels.

$${y}_{i} = {V}_{D D} \cdot \frac{{a}_{i}}{{N}_{1}} , {a}_{i} ∈ ( - \frac{{N}_{1}}{2} , + \frac{{N}_{1}}{2} ) \qquad ( 2 )$$

Concurrently, elements of matrix B, bᵢ, are encoded into spike timings. Eq. 3 defines this temporal encoding, where tᵢ represents the decay time since the firing time t′ᵢ of the i-th spike and N₂ is the number of discrete for bᵢ.

$${e}^{\frac{- {t}_{i}}{τ}} = \frac{{b}_{i}}{{N}_{2}} ⇒ {t}_{i} = - τ ln \frac{{b}_{i}}{{N}_{2}} , {b}_{i} ∈ [ 1 , {N}_{2} ] \qquad ( 3 a )$$

$${t}_{i}^{′} = {t}_{1} - {t}_{i} = - τ ln \frac{1}{{N}_{2}} + τ ln \frac{{b}_{i}}{{N}_{2}} = τ ln {b}_{i} \qquad ( 3 b )$$

This dual encoding of amplitude and timing effectively embeds the elements of matrices A and B into spike trains. Consequently, matrix multiplication at capacitors is triggered by the series of spikes with specific amplitudes at defined timings. The dot product of two vectors is then obtained by measuring the instantaneous capacitor voltage, Vₜ, as described in Eq. 4 (combining Eqs. 1,2,3), where K represents a constantscaling factor. This spiking-based approach therefore provides a framework for energy-efficient and high-performance matrix multiplication in neuromorphic computing systems.

$${V}_{t} = \sum {X}_{i} {W}_{i} = \frac{{V}_{D D}}{{N}_{1} {N}_{2}} \frac{{T}_{w}}{τ} \cdot \sum {a}_{i} \cdot {b}_{i} \qquad ( 4 a )$$

$$⇒ \sum {a}_{i} \cdot {b}_{i} = {V}_{t} \cdot \frac{τ}{{T}_{w}} \cdot \frac{{N}_{1} {N}_{2}}{{V}_{D D}} = {V}_{t} \cdot K \qquad ( 4 b )$$

### III: Implementation Techniques

### A. Encoding Elements

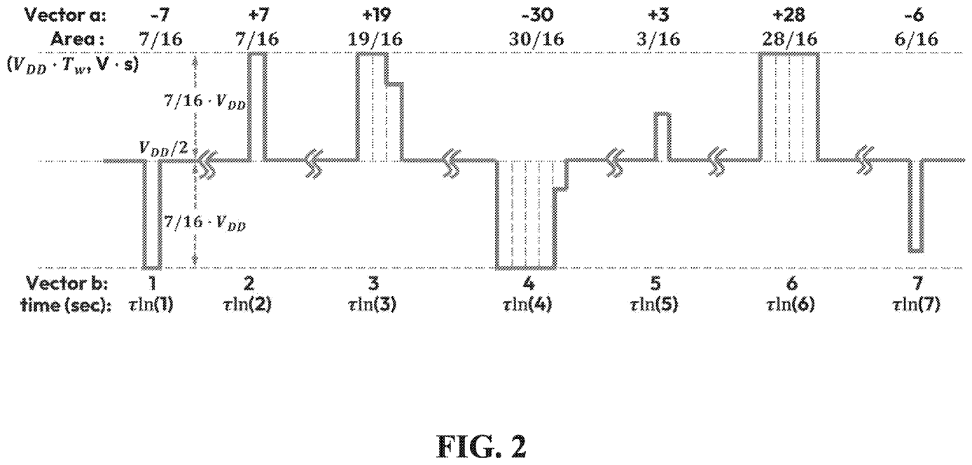

Encoding a matrix A row into spike amplitudes requires a digital-to-analog converter (DAC) to transform digital data into analog signals. A 4-bit signed encoding scheme quantizes these row elements into 15 discrete amplitude levels representing integer values from −7 to +7, with zero mapped to a reference voltage (V_{DD}/2). Positive spikes (+1 to +7) scale amplitudes proportionally from 9/16 V_{DD} to 15/16 V_{DD}, while negative spikes (−1 to −7) scale from 7/16 V_{DD} to 1/16 V_{DD}. A matrix B column is encoded with a 4-bit signed scheme that uses spike timing controlled by a digital clock. In this temporal encoding, the sign of negative elements in B is transferred to the corresponding elements of matrix A. Spike occurrence times are thus quantized into 7 discrete temporal levels (1 to 7), computed using Eq. 3b. When a matrix Bcolumn contains repeated elements, consecutive spikes could be generated at that time slot to represent the accumulation, as shown in FIG. 2. FIG. 2 shows an amplitude-temporal dual encoding scheme. Spike amplitudes represent the row vector a of matrix A, and spike timings represent the column vector b of matrix B. Spike width modulation is employed-by increasing the duration of spikes

$$( {T}_{s e q}^{i} ) -$$

to encode the amplitude values beyond the highest discrete level.

### B. Decoding Results

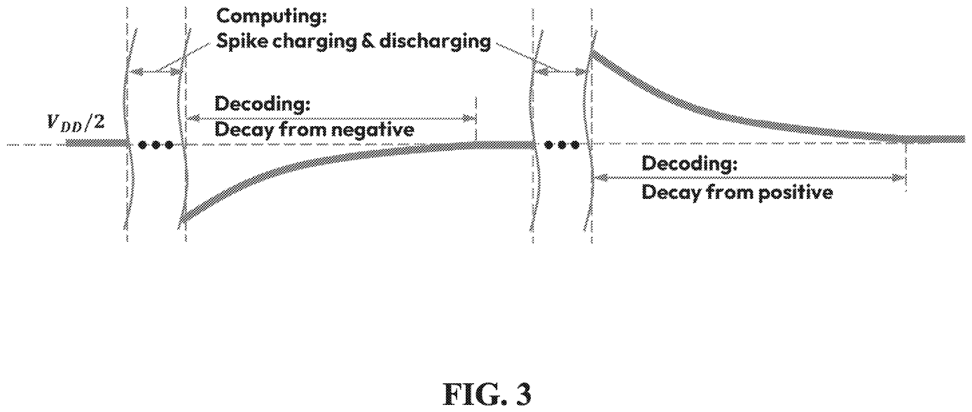

The computation result derived from the instantaneous capacitor voltage (Eq. 4b) requires conversion from an analog to a digital representation. Traditional ADCs are avoided here due to their prohibitive power consumption and area overhead, limiting scalability for large-scale computation. Instead, the capacitor voltage is digitized using its intrinsic decay behavior: the computational output is decoded based on the number of clock cycles elapsed as the voltage converges to equilibrium following charging and discharging triggered by input spikes, as shown in FIG. 3. FIG. 3 shows a time-based decoding scheme. The analog capacitor voltage is converted to digital clock cycles based on the capacitor's voltage convergence time to equilibrium. The clock cycle count serves as an address to access a ROM module, retrieving the corresponding digital computation result. Considering large matrix sizes (e.g. 5120× 5120), the computational output is encoded with a 12-bit signed scheme, providing a numerical range from −2047 to +2047.

This time-based decoding approach offers several advantages: it eliminates the need for traditional power-intensive and area-consuming ADCs and effectively utilizes the capacitor's inherent reset phase for analog-to-digital conversion. Further-more, by employing the clock cycle count as a ROM address, this method improves tolerance against result variability. Multiple ROM addresses map to the same output value, ensuring reliable computation despite manufacturing process variations affecting decay times. Consequently, this decoding strategy enhances accuracy, scalability, and energy efficiency in large-scale computational systems.

### C. Parallelizing Matrix Multiplication

In matrix-vector multiplication (A×b), each result is obtained from the dot product between a row of matrix A and vector b. These dot products are inherently independent and can thus be computed in parallel, with each row assigned to a separate computing core. Parallelizing N rows across N cores significantly accelerates the computation.

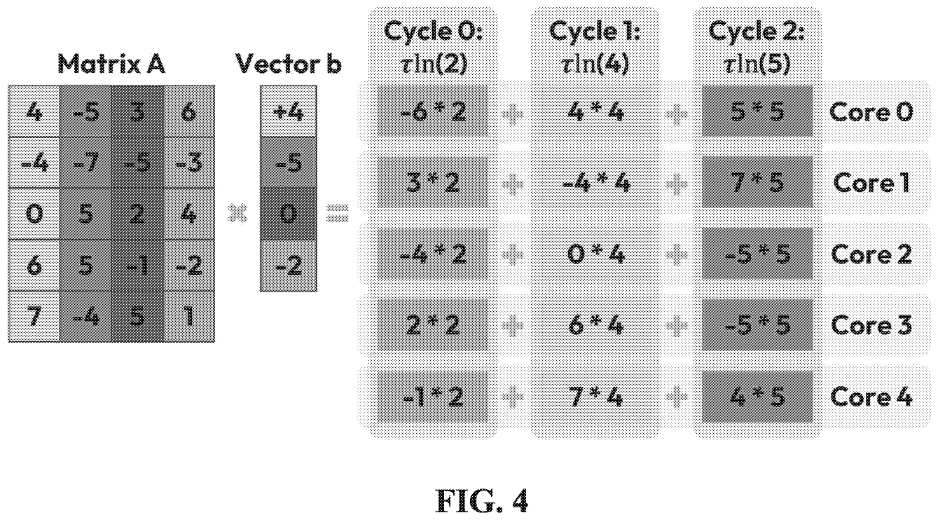

Row-wise parallelism: FIG. 4 shows row-parallel computation on matrix A: Each row of A is concurrently multiplied with the column vector b from matrix B. The illustration of FIG. 4 demonstrates this concept by allocating each matrix row to an individual core, enabling simultaneous dot-product calculations with vector b. This approach exploits intrinsic parallelism, greatly improving computational efficiency as the matrix size increases. In the illustrated example, a five-row matrix utilizes five cores, each integrated with a capacitor that accumulates charge proportional to the computed dot product. Unlike traditional analog crossbar arrays, which sequentially activate rows for vector-matrix multiplication, the present architecture concurrently processes multiple input vectors across multiple rows. This parallelization is especially advantageous for large-scale matrix multiplications required by long-context Transformer architectures in modern large language models.

Encoding matrix A in spike amplitude: Elements of each row in matrix A are encoded as amplitudes in temporal spike sequences generated by individual cores. Spike amplitudes are centered around a baseline voltage V_{DD}/2, with positive matrix elements increasing amplitude above this baseline and negative elements decreasing it below. Each column of A corresponds to the spikes emitted across independent cores at a specific time. For instance, in FIG. 4, at time τ·ln(4), all cores produce spikes whose amplitudes correspond to the elements of A's first column. Thus, a row of A determines the spike amplitudes for a single core, while a column of A defines the spike amplitudes across all cores at a given time.

Encoding vector b in spike timing: The vector b determines the spike timing for each column of A. Specifically, the spike generation time for column i is regulated by the absolute value of corresponding element bᵢ. For example, whether bᵢ equals 5 or +5, spikes associated with column i occur at time τ·ln(5). The negative sign of bᵢ is used to invert the corresponding column elements of A. In other words, the absolute value of bᵢ sets the spike timing, while its negativity handles the sign adjustment of A's associated column. Consequently, the vector b establishes the temporal sequence of spikes, while the matrix A dictates their amplitudes.

In summary, this approach achieves parallel matrix-vector multiplication by distributing row-wise dot-product computations across multiple cores, each performing independent calculations using spike-based encoding of matrix and vector values. The final result is represented as the measurable voltage accumulated within each core. This parallel approach enables enhanced computational performance for large-scale matrices.

### D. Simplifying Matrix Multiplication

To efficiently compute the dot product of two n-dimensional vectors a and b, value repetition in the quantized vector b is leveraged to reduce the number of multiplication operations. When b is quantized to a low-bit precision (e.g., 4-bit), many elements become identical, thereby allowing common values to be factored out. Specifically, we group elements of a based on the unique absolute values in b, adjust the sign of each ai by the sign of the corresponding bᵢ, and accumulate these grouped elements before performing a single multiplication per unique value.

Formally, let v represent each distinct quantized value in |b|. Define index sets Iₚᵥ={i|b|=+v} and Iₙᵥ={i| bᵢ=−v}. The dot product can then be rewritten as:

$$a \cdot b = {\sum }_{v ∈ Unique ( \vert b \vert )} ( ( {\sum }_{i ∈ {I}_{p v}} {a}_{i} + {\sum }_{i ∈ {I}_{n v}} - {a}_{i} ) \times v ) \qquad ( 5 )$$

This method reduces multiplications to constant time complexity, as the number of multiplications depends only on the number of unique quantized values in |b|, capped at 2^{k-1} for a k-bit quantization. For instance, with 4-bit quantization, at most 8 multiplications are required regardless of vector length n, with the remaining operations being simple additions. Thus, when the vector b exhibits low entropy, this approach provides substantial efficiency gains over traditional methods, achieving constant-time complexity in analog computations.

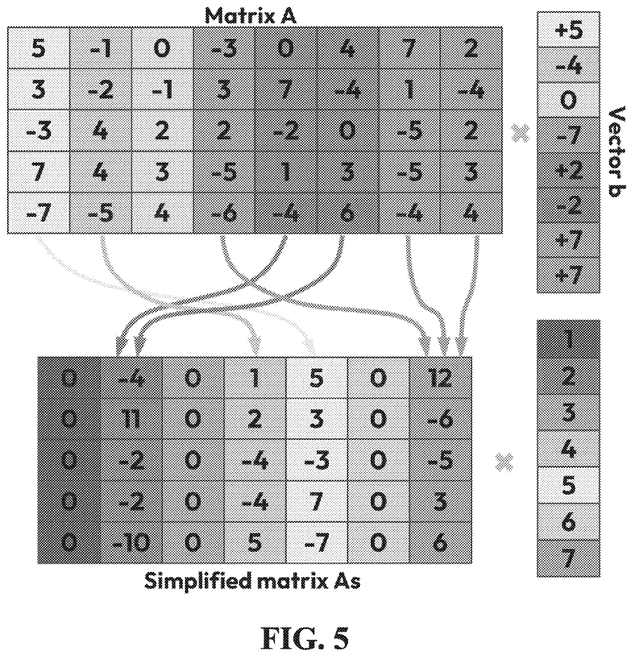

Extending this optimization to matrix-vector multiplication, consider a n×n matrix A and an n-dimensional vector b. By applying the same grouping and sign adjustment strategy synchronously to each row of A, we form a simplified matrix Aₛ, as illustrated by FIG. 5 which shows multiplication simplification by exploiting repeated absolute values in columns of matrix B to group corresponding columns of matrix A. Specifically, we first adjust the signs of A's columns according to b's signs, then aggregate columns corresponding to identical values in b into a new matrix Aₛ. Thus, the matrix-vector product A·b is computed efficiently as Aₛ multiplied by a fixed-length vector containing unique values from |b|. Since the physical multiplication is executed in parallel across all capacitor cells, the time required for the multiplication is independent of the original matrix dimensions. This reduces the multiplications to constant time complexity, yielding substantial efficiency gains, particularly for low-bit quantized vectors.

Beyond improving computational efficiency, this method reduces spike events (i.e. physical analog multiplications) by grouping positive and negative contributions before they trigger separate spike events, thereby mitigating cumulative errors from repeated capacitor charging and discharging. Moreover, this method relaxes the timing constraint discussed in the following Sec. IV-B. Ultimately, these optimizations enhance both the reliability and scalability of matrix multiplication operations in analog computing cores.

### IV: Theoretical Constraints on Computation

### A. Amplitude Constraint

The result of vector multiplication is determined by measuring the number of clock cycles required for the capacitor's voltage to decay from an initial voltage (Vₜ) to its equilibrium voltage. To ensure accurate measurement of the decay time corresponding to the smallest product magnitude (unity), the unity's initial capacitor voltage (Vₜ) should exceed a minimum measurable threshold voltage (Vₜₕ). This threshold represents the smallest detectable deviation from equilibrium. This requirement, formalized as the amplitude constraint (Eqs. 6), guarantees valid and quantifiable measurement outcomes. In these equations, N₁ denotes discrete quantization levels of spike amplitude, N₂ indicates discrete quantization levels of spike timing, and V_{DD} is the source voltage.

$$min ( {V}_{t} ) = {X}_{min} \cdot {W}_{min} = \frac{{V}_{D D}}{{N}_{1}} \frac{{T}_{w}}{τ} \cdot \frac{1}{{N}_{2}} \qquad ( 6 a )$$

$${V}_{t} \geq {V}_{t h} ⇒ \frac{τ}{{T}_{w}} \leq \frac{{V}_{D D}}{{N}_{1} \cdot {N}_{2} \cdot {V}_{t h}} \qquad ( 6 b )$$

### B. Timing Constraint

When a column of matrix B contains repeated elements, consecutive spikes may occur within a single allocated time slot, using spike-width modulation to represent accumulated values (see FIG. 2). To prevent misalignment or overlap, the width of these modulated spikes

$$( {T}_{s e q}^{i} )$$

should not exceed the allocated time slot duration. This requirement, termed the timing constraint, ensures sufficient spacings to reliably accommodate width-modulated spikes within their respective time slots, as formalized by Eqs. 7. Specifically, the minimal interval between adjacent spike occurrences, denoted as

$$Δ {t}_{min}^{′}$$

and specified by Eq. 7a, should exceed the maximum possible width of modulated spikes (Eqs. 7b). Here, Σ represents the maximum accumulated magnitude in the simplified matrix Aₛ, and 7 is the maximum spike amplitude.

$$Δ {t}_{min}^{′} = τ ln {N}_{2} - τ ln ( {N}_{2} - 1 ) \qquad ( 7 a )$$

$$max ( {T}_{s e q}^{i} ) = ⌈ \frac{\sum }{7} ⌉ \cdot {T}_{w} \qquad ( 7 b )$$

$$Δ {t}_{min}^{′} \geq max ( {T}_{s e q}^{i} ) ⇒ \frac{τ}{{T}_{w}} \geq ⌈ \frac{\sum }{7} ⌉ \cdot {( ln \frac{{N}_{2}}{{N}_{2} - 1} )}^{- 1} \qquad ( 7 c )$$

### C. Result Sensitivity

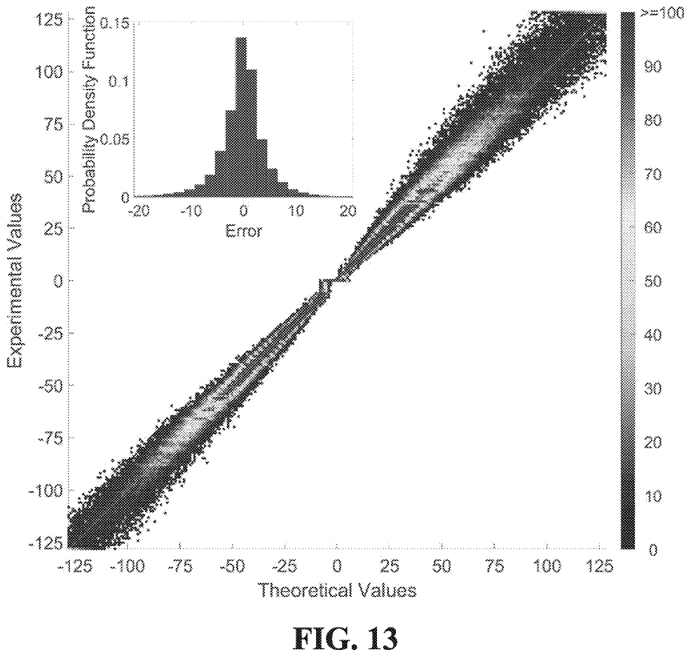

During the decoding phase, the decay time (t), required for the capacitor voltage to decline from an initial peak or trough voltage (Vₜ) toward the threshold voltage (Vₜₕ), exhibits a logarithmic function, as illustrated by Eq. 8a. This characteristic means that for larger initial voltages, the decay time tends to saturate, resulting in reduced sensitivity to changes in initial voltage. Conversely, lower initial voltages lead to higher sensitivity, where small voltage differences significantly impact the decay time, thus improving measurement accuracy. The sensitivity of decay time measurements relative to the initial voltage is explicitly described in Eq. 8b. It demonstrates that decay time sensitivity is inversely proportional to the initial voltage: higher initial voltages result in lower sensitivity and reduced accuracy, whereas lower initial voltages provide higher sensitivity and increased accuracy. This relationship explains the error distribution observed in prototype experiments (see FIG. 13, Sec. VI). Larger computational outputs, corresponding to higher initial voltages, exhibit increased measurement error, while smaller outputs with lower initial voltages result in reduced error.

$${V}_{t h} = {V}_{t} \cdot {e}^{- \frac{t}{τ}} ⇒ t = τ \cdot ln \frac{{V}_{t}}{{V}_{t h}} \qquad ( 8 a )$$

$$\frac{d t}{d {V}_{t}} = τ \cdot \frac{{V}_{t h}}{{V}_{t}} \cdot \frac{1}{{V}_{t h}} = \frac{τ}{{V}_{t}} \qquad ( 8 b )$$

### V: System Architecture

### A. Overall Architecture

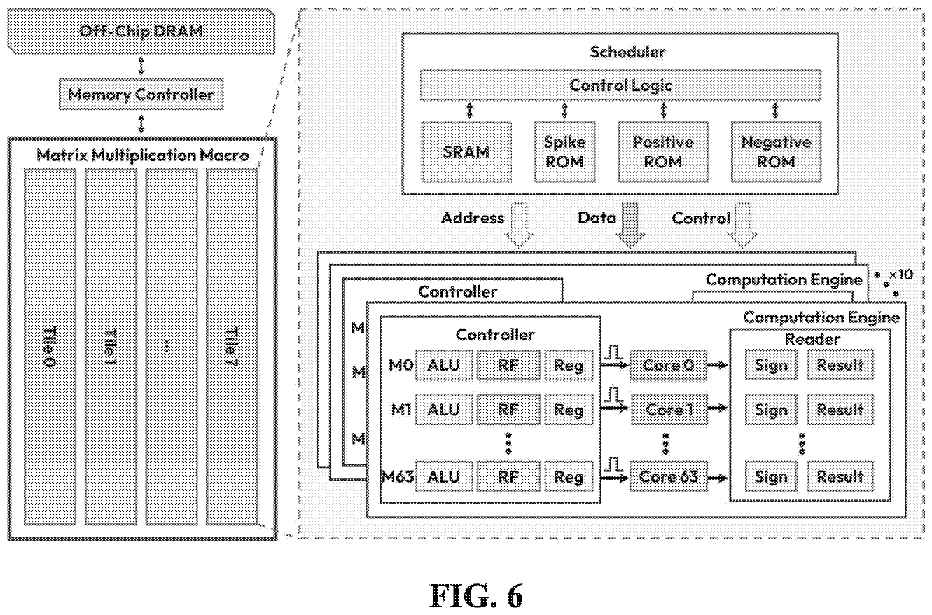

The proposed WireLightning architecture efficiently executes matrix multiplication between A and B, where each matrix element is represented as a 4-bit integer. FIG. 6 shows the overall system architecture of WireLightning, which comprises eight tiles interconnected with a memory controller. Each tile contains a scheduler and ten computation engines. Each computation engine is further structured with a controller, 64 analog cores, and a reader module. As illustrated in FIG. 6, this architecture comprises eight parallel tiles coordinated by a memory controller for the multiplication of two 5120×5120 matrices. Each tile concurrently multiplies 640 rows of matrix A with one column vector from matrix B, enabling simultaneous computation across all 5120 rows. The memory controller manages data transfers, loading matrices A and B from off-chip DRAM to on-chip memory and subsequently transferring computed results back to DRAM.

Within each tile, a hierarchical structure comprises one scheduler and 10 computation engines. Each engine computes the product of 64 row vectors from matrix A with a column vector from matrix B. The scheduler manages addresses, data, and control signals for each engine. Each computation engine internally consists of a controller, 64 computing cores, and a reader module. Each computing core calculates the dot product of one row vector from matrix A and a column vector from matrix B, driven by spike sequence signals generated by the controller. The reader retrieves results from these cores. Consequently, each scheduler coordinates 10 controllers, collectively managing 640 cores performing parallel vector multiplication. Thus, all eight tiles together perform simultaneous multiplication of 5120 row vectors by a single column vector. Detailed descriptions of each module are provided in subsequent sections.

### B. Computing Core

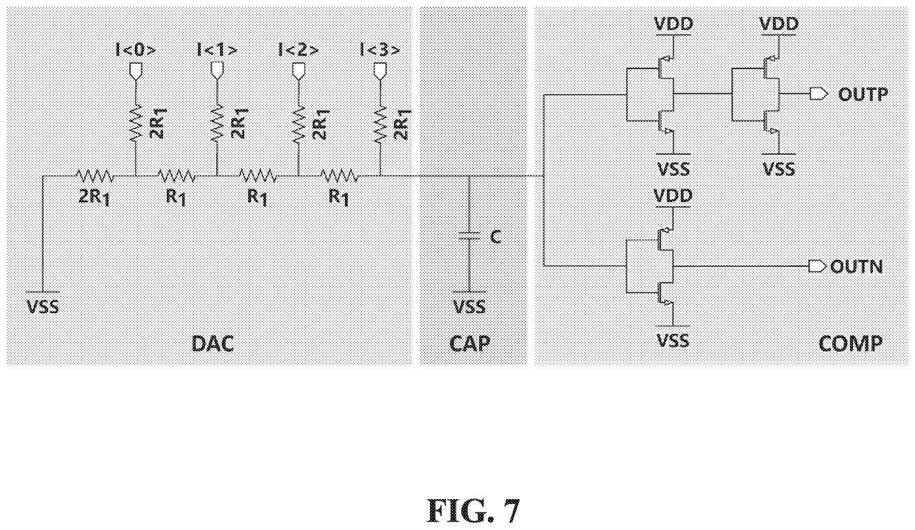

The computing core primarily performs vector multiplication through controlled capacitor charging and discharging driven by spike signals. FIG. 7 shows a schematic diagram of the analog computing core, comprising three components: a resistor-ladder DAC, a capacitor (CAP), and greater/less-than comparators (COMP).

DAC: The requirements of the DAC in each computing core include high energy efficiency, simple architecture for large-scale integration, and high dynamic response. The present invention adopts an R-2R ladder DAC, which is a passive resistor network that directly divides the reference voltage based on digital input, thereby enabling theoretically instantaneous analog outputs once inputs stabilize. Its purely passive nature eliminates active, power-consuming components, thus ensuring low power consumption. Additionally, the ladder's simple structure, utilizing only two repeating resistor values, minimizes process mismatch errors, simplifies fabrication, and enhances scalability. Moreover, the R-2R ladder inherently provides necessary resistance for the core's RC circuits, facilitating component reuse and eliminating the need for additional resistors. Thus, R-2R ladder DACs are provided for the analog computing cores.

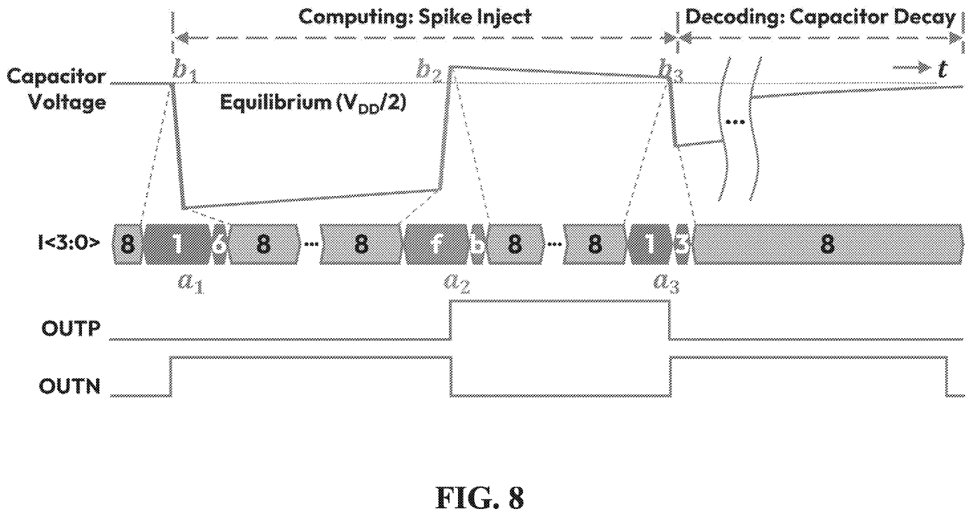

The R-2R ladder DAC regulates capacitor charging and discharging by generating analog spike sequences. The capacitor voltage begins decaying toward equilibrium when the DAC output equals V_{DD}/2, corresponding to a digital input (I [symbol] 3:0 [symbol] ) value of 8. Inputs above this value cause rapid capacitor charging followed by a gradual discharge back to equilibrium once the input returns to 8; inputs below cause rapid discharging and slow recharging to equilibrium upon restoration to 8, as depicted in FIG. 8. FIG. 8 shows responses of the analog computing core, including capacitor voltage, greater-than comparator output (OUTP), and less-than comparator output (OUTN), in response to the digital signals (I [symbol] 3:0 [symbol] ). Spike amplitudes produced by the DAC range from 1/16 V_{DD} to 15/16 V_{DD} for digital input values from 1 to 15, corresponding to matrix elements ranging from −7 to +7.

CAP: A grounded capacitor is positioned between the DACoutput and the COMP input, serving as the primary component for vector multiplication. Since the COMP input is directly connected to transistor gates, the DAC exclusively controls the charge injection and release of the capacitor. This design minimizes the charge leakage, and thus preserves computational accuracy and signal integrity.

COMP: The comparators comprise two distinct paths: a positive-result path (OUTP) containing two inverters, and a negative-result path (OUTN) with a single inverter (FIG. 7). OUTP outputs logical 1 when capacitor voltage is above equilibrium (V_{DD}/2); OUTN outputs logical 1 when capacitor voltage is below equilibrium (FIG. 8). Voltage deviations from equilibrium are thus converted into digital signals. Increased capacitor voltage on the positive path or decreased voltage on the negative path extends the duration of high-level outputs. Consequently, the analog results are decoded into digital values based on the clock cycles required for the capacitor voltage to return to equilibrium.

In summary, the computing core completes vector multiplication once all spike signals have been transmitted to the capacitor and computational results have been decoded by measuring clock cycles needed for the capacitor voltage to stabilize back to equilibrium. This method integrates analog-to-digital conversion within the capacitor reset process, removing the need for traditional high-power, large-area ADCs and enhancing scalability.

### C. Controller

The controller consists of 64 identical modules, each interfacing with one computing core. These modules operate concurrently and are synchronized by a common clock to ensure cohesive execution across all cores. Each module contains three key components: an arithmetic logic unit (ALU) supporting addition and subtraction; a register file (RF) storing both the original and simplified row vectors (A and Aₛ); and a temporary register (Reg) holding spike-amplitude data during spike generation.

The controller operates in two primary phases: matrix simplification and spike generation. In the matrix simplification phase, each of the 64 identical modules independently transforms its stored matrix row vector from A to a simplified form Aₛ. Upon receiving enable and register file address signals, each module performs: (1) loads the original row vector from its register file; (2) iteratively processes and accumulates each element using the ALU; and (3) stores the simplified row vector As back into the register file.

During the spike generation phase, modules concurrently produce discrete spike signals for their respective computing cores, synchronized by a common clock. Upon receiving spike-generation enable and register file address signals, each module executes: (1) transfers the simplified vector As from the register file into the temporary register. (2) emits analog spike signals each clock cycle, with spike amplitude set by the current register value. Positive values generate spikes above the equilibrium level (V_{DD}/2), and negative values yield spikes below it. (3) adjusts (increments or decrements) the register value toward zero after each spike until it reaches zero, ending spike emission.

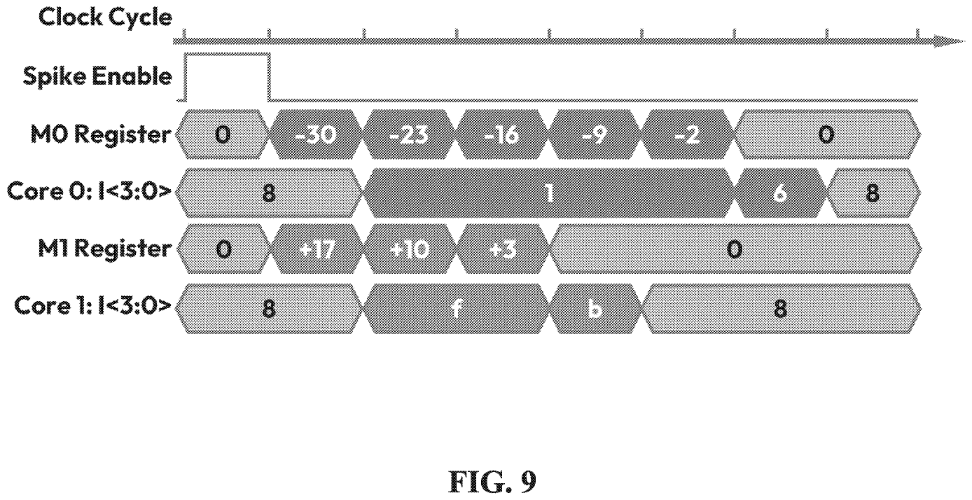

FIG. 9 shows positive and negative spike generation based on register values. Upon activation of the spike enable, a negative value (−30) in register M0 generates the input signal (I [symbol] 3:0 [symbol] ) for Core 0, resulting in a negative spike. Conversely, a positive value (+17) in register M1 produces the input signal (I [symbol] 3:0 [symbol] ) for Core 1, resulting in a positive spike. An illustrative example (see FIG. 9) demonstrates spike dynamics: Module 0 (M0) initially loads −30, emitting negative spikes that incrementally approach zero; Module 1 (M1) loads +17, emitting positive spikes decreasing toward zero. Spike generation concludes when all modules simultaneously reach zero.

### D. Reader

The reader module monitors the 64 computing cores and collects their computational results by examining each core's positive and negative result ports to detect when equilibrium (computation completion) is reached. It comprises 64 identical modules, each responsible for a single core and containing a sign-check unit and a result-collection unit. The sign-check unit samples the positive and negative result ports before their return to low, storing these outputs in a two-bit sign register. The sign register determines whether equilibrium was achieved through charging or discharging by recording the last port to return low. If the positive-result port returned low last (indicating equilibrium occurred through discharge), the computation result is positive. Conversely, if the negative-result port returned low last (indicating equilibrium occurred through charging), the computation result is negative. The result-collection unit stores the final computed value. Using the information from the two-bit sign register, it selects the appropriate positive or negative computational outcome, broadcasted by the scheduler corresponding to the current decay time, and stores this result.

### E. Scheduler

The scheduler manages the matrix-vector multiplication pipeline by generating address, data, and control signals to ensure efficient computation. It primarily consists of SRAM (caching a column vector of matrix B), a spike ROM (storing clock cycles for spike events), positive and negative result ROMs (containing respective computational outcomes per clock cycle during decoding), and control logic circuitry responsible for generating synchronization and operational signals. A detailed description of signals produced at each pipeline stage is provided in the following section.

### F. Workflow

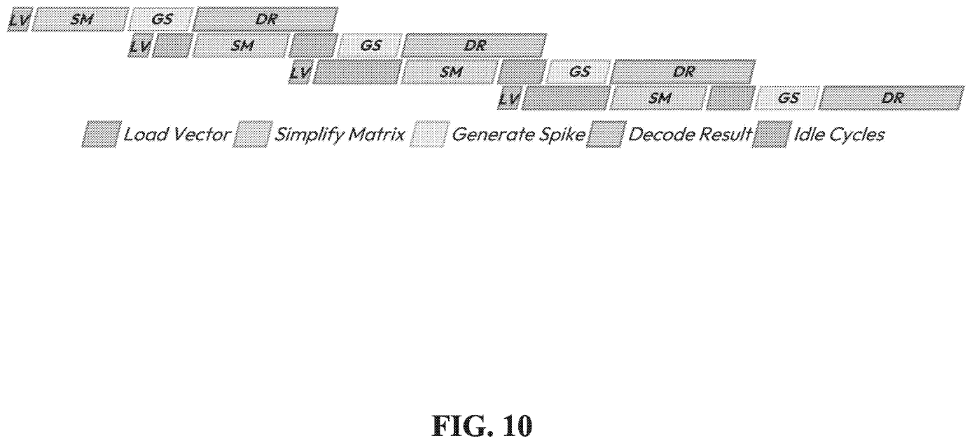

FIG. 10 shows a workflow of the WireLightning, illustrating the pipelined processing stages: load vector, simplify matrix, generate spike, and decode result. The scheduler executes matrix-vector multiplication through a four-stage pipelined architecture designed for optimal computational efficiency (see FIG. 10). Stage 1: Load Vector (LV). The scheduler loads a column vector of matrix B from off-chip DRAM into the SRAM. Stage 2: Simplify Matrix (SM). The scheduler provides address and control signals, prompting controllers to simplify matrix A based on the loaded vector. Signals include simplification enable, addresses for data accumulation, and storage addresses for simplified results. Stage 3: Generate Spike (GS). Controllers produce spikes synchronized by scheduler signals derived from the spike ROM timing, ensuring precise execution of spike events. Stage 4: Decode Result (DR). Analog computational results are digitized during this stage. At each clock cycle, the scheduler retrieves corresponding positive and negative values from the ROMs and forwards these to reader modules. Each reader then determines the final digital result by selecting the appropriate signed value. This pipelined architecture significantly enhances the throughput of matrix-vector multiplication. Experimental results relating to performance gains are described in subsequent sections.

Considering pipeline dependencies, where each stage can only execute once its adjacent stages are idle, the theoretical execution time for matrix-matrix multiplication is thus expressed as:

tₜₒₜₐₗ=(t_{LV}+t_{SM}+t_{GS}+t_{DR})+(n−1)×(t_{GS}+t_{DR}) (9)
where n is the number of columns in matrix B, and t_{LV}, t_{SM}, t_{GS}, and t_{DR} represent the execution times for vector loading, matrix simplification, spike generation, and result decoding, respectively. This formulation captures both individual stage latencies and pipeline dependencies.

### VI: EXPERIMENTAL RESULTS

### A. PCB-Level Results

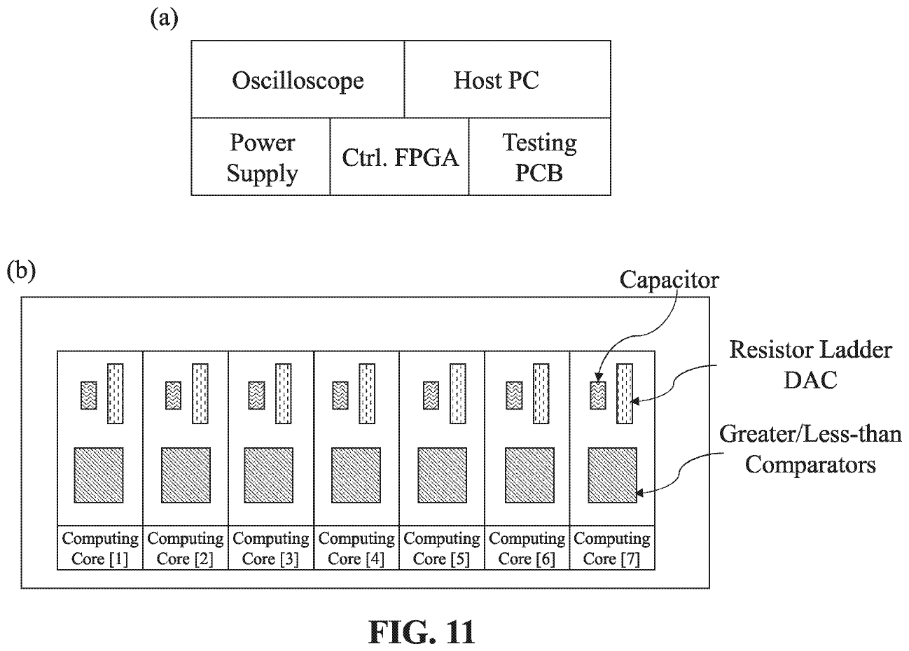

FIG. 11 shows a schematic experimental setup for PCB-level validation with parts (a) and (b). Part (a) schematically shows a host computer, a controller FPGA board, a test board hosting analog computing cores, a power supply, and an oscilloscope. Part (b) schematically shows the test board including a plurality of computing cores, each computing core including a resistor-ladder DAC, a capacitor, and greater-than and less-than comparators. It should be noted that FIG. 11 is a schematic representation provided for illustrative purposes; the relative sizes and proportions of the components shown therein do not reflect precise scale relationships or actual dimensions in an integrated circuit implementation. The experimental setup of FIG. 11 may include a host computer, a PYNQ Z2 FPGA controller board, a custom analog test board, a power supply, and an oscilloscope. The custom test board, powered by the power supply, may host seven computing cores, thereby enabling concurrent execution of seven vector-vector multiplications. Each computing core may include an R-2R ladder, a computing capacitor characterized by a 55 μs time constant (τ), realized through an 11-nF capacitor and an effective 5-kΩ resistor derived from the R-2R ladder, and greater-than and less-than comparators. The oscilloscope may monitor capacitor voltage and positive and negative result-path voltages. Within the PYNQ Z2, programmable logic (PL) may implement the scheduler, controller, and reader modules. The FPGA I/O ports may operate at a 3.3-V logic level, thereby providing a DAC output range between 1/16× 3.3 V and 15/16× 3.3 V. Digital circuits within the programmable logic may operate at a 1 MHz clock frequency, thereby producing DAC output spikes with a width (T_{w}) of 1 μs.

For matrix multiplication, the host computer generates two random matrices, A (7× 8) and B (8× 8), containing uniformly distributed 4-bit signed integers from −7 to +7. Matrix A is transferred to the controller module's registers, while matrix B is sent to the scheduler's memory via AXI4-Stream through the PYNQ Z2 processing system (PS). Upon receiving a “start” signal from the host via AXI4-Lite, the scheduler initiates multiplication. Results are subsequently transferred from the reader module back to the host computer through the PS via AXI4-Stream.

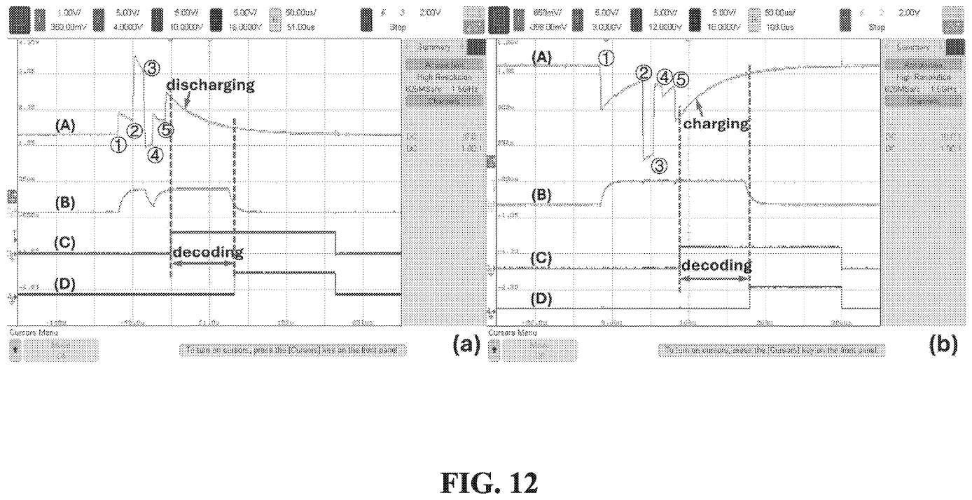

FIG. 12 shows oscilloscope waveforms illustrating capacitor voltage and comparator outputs with parts (a) and (b), wherein part (a) shows a positive calculation result and part (b) shows a negative calculation result, and in each of parts (a) and (b), a first trace (A) represents capacitor voltage, a second trace (B) represents a comparator output (positive/negative result-path), a third trace (C) represents a decode-result start signal, and a fourth trace (D) represents a completion signal.

The illustration of FIG. 12 shows experimental waveforms for a single computing core performing two vector multiplications, one producing a positive result in part (a) of FIG. 12 and the other producing a negative result in part (b) of FIG. 12. A first trace (A) represents capacitor voltage, a second trace (B) indicates a positive result-path output in part (a) of FIG. 12 or a negative result-path output in part (b) of FIG. 12, a third trace (C) marks the start of the decode-result phase, and a fourth trace (D) indicates return to equilibrium and completion of computation. Thus, the interval between the third trace (C) and the fourth trace (D) reflects the capacitor-voltage decoding time. In part (a) of FIG. 12, the capacitor discharges to equilibrium and the positive result path returns low last, confirming a positive result. In part (b) of FIG. 12, the capacitor charges toward equilibrium and the negative result path returns low last, indicating a negative result. Each capacitor-voltage trace exhibits five spike signals corresponding to the five unique absolute values in vector b.

FIG. 13 shows frequency distribution of 560,000 vector multiplication results from PCB experiments. Dots represent individual vector-vector multiplication results ranging from −127 to +127, and shading density indicates measurement frequency. Inset: Probability density function of the error between experimental and theoretical results.

The illustration of FIG. 13 demonstrates the distribution of 560,000 vector multiplications (10,000 matrix multiplications across seven cores), plotting theoretical results (−127 to +127) against experimental measurements. Each dot represents an individual vector-multiplication result. Shading density indicates measurement frequency, and the inset details the error distribution between experimental and theoretical values.

Result Sensitivity Analysis: FIG. 13 shows that higher experimental errors are associated with larger absolute theoretical results. Within [−50, +50], experimental results closely match theoretical values, with a root mean square error (RMSE) of 2.95. Across the entire [−127, +127] range, RMSE increases to 4.58 (range-normalized RMSE: 1.80%). This phenomenon aligns with Eq. 8b, which indicates that smaller capacitor initial voltages (Vₜ) lead to enhanced decay-time measurement sensitivity and hence accuracy, while larger Vt reduces sensitivity and increases errors.

Amplitude Constraint Analysis: The actual comparator threshold slightly exceeds the theoretical threshold (Vₜₕ in Eq. 6b) for detecting the minimum voltage deviation, given the PCB parameters (τ=55 μs, T_{w}=1 μs, V_{DD}=3.3 V, N₁=15, and N₂=7). This causes the theoretical results within [−3, +1] to appear as zero due to comparator inactivity.

Timing Constraint Analysis: The timing constraint specified by Eq. 7c, which requires simplified matrix (Aₛ) values to remain no more than 59 to prevent spike overlap, given the PCB parameters, is satisfied in experiments. The theoretical maximum Aₛ value of 56 occurs when all eight input vector elements have identical values of either maximum +7 or minimum −7.

Overall, PCB-level experiments validate the accuracy and practicality of the proposed analog matrix-multiplication paradigm, confirming both theoretical computation and constraint equations. The next part involves evaluating this paradigm in an integrated chip implementation.

### B. System Configuration for Chip Design and Evaluation

The digital components, including the controller, reader, and scheduler, are implemented at the register-transfer level (RTL) using Verilog HDL. Functional simulation and debugging are performed with Synopsys VCS and Verdi. After RTL verification, Synopsys Design Compiler synthesizes the design into a gate-level netlist utilizing a 40-nm standard cell library. Physical implementation, including layout, routing, and power analysis, is performed using Cadence Innovus, with the digital modules configured to operate at a clock frequency of 1 GHz.

The analog computing core is designed using the 40-nm process design kit (PDK), with schematic design and transient simulations performed using Cadence Virtuoso Spectre. Power consumption metrics are subsequently extracted for each component from Virtuoso.

Mixed-signal co-verification is conducted using Cadence Virtuoso AMS, integrating digital Verilog and analog SPICE models. Custom analog layouts are developed within Virtuoso, while digital layouts are generated using Innovus. Final chip integration is performed, thereby passing design rule checking (DRC) and layout-versus-schematic (LVS) verification in Calibre.

### C. Chip Latency

Section V-F details the computation workflow of the matrix multiplication A×B, where both matrices are 5120×5120 in size. Multiplication is performed column-wise: each column vector of B is sequentially loaded into the scheduler and multiplied in parallel with row vectors of A until all columns of B are processed.

TABLE I
TIME CONSUMPTION FOR EACH PIPELINE TASK

| Pipeline Stage | LV | SM | GS | DR |
|---|---|---|---|---|
| Time (ns) | 640 | 1280 | 533 | 2529 |

Table I summarizes the mean execution times for each stage. Stage 1 (LV), which loads one column of B at 8 elements per cycle, consumes 640 cycles. Stage 2 (SM), summing 4 columns of A per cycle, requires 1280 cycles. Stage 3 (GS), generating all 7 spikes, takes 533 cycles. Stage 4 (DR), decoding analog signals via natural capacitor decay, averages 2529 cycles.

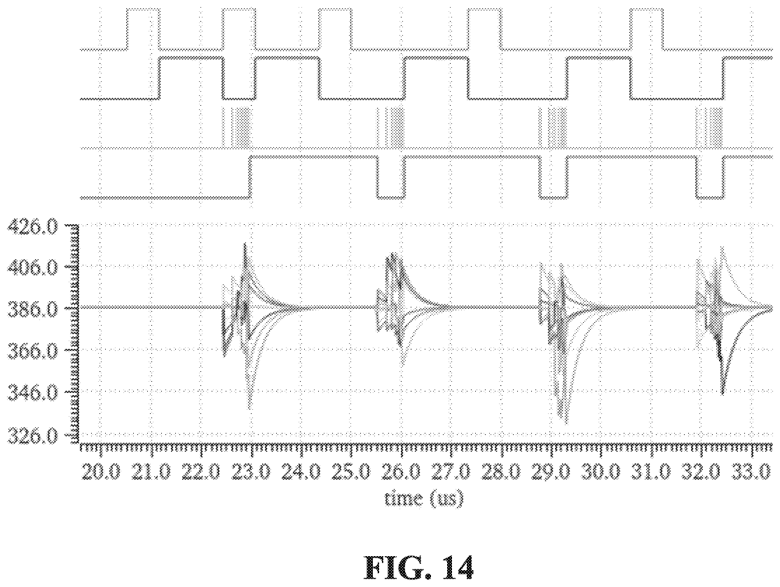

Using Table I and Eq. 9, the total latency for the complete matrix multiplication of A and B is 15.6794 ms, computed as: 640 ns+1280 ns+533 ns+2529 ns+ (533 ns+2529 ns)×5119, where the first four terms represent the processing of the initial column of B and the final term accounts for the iterative execution of stages 3 and 4 across the remaining 5119 columns. The pipeline processing stages are illustrated in FIG. 14. FIG. 14 shows chip simulation results from Virtuoso that illustrate the operation of the WireLightning and the resulting capacitor voltages across the computing cores. The upper panel displays four digital enable signals corresponding to the pipelined processing stages, namely load vector, simplify matrix, generate spike, and decode result. The lower panel shows analog capacitor voltages corresponding to respective computing cores. Notably, capacitor voltage decoding (Stage 4) constitutes approximately 82.6% of the total processing time.

Computational efficiency and accuracy are significantly influenced by the capacitor circuit's time constant (τ). A smaller τ shortens spike generation (Eq. 3b) and reduces recovery time to equilibrium voltage (Eq. 8a), thus enhancing throughput. However, reduced τ compromises decoding sensitivity to the initial voltage (Eq. 8b), decreasing measurement accuracy. An optimal τ of 256 ns (C=500 fF and R=512 kΩ) achieves the balance between efficiency and accuracy.

### D. Chip Power and Area

Chip power and area consumption (Tabs. II and III) are evaluated via post-layout simulations using Cadence Virtuoso AMS and Cadence Innovus at a 40-nm technology node with a nominal 0.9-V supply. Digital components operate at 1 GHz. Analog core power consumption was determined by simulating a 64-core computation engine performing 3,200 [64, 5120]×[5120, 128] matrix multiplications (~393.86 μs each), covering vector loading, matrix simplification, spike generation, and result decoding phases. Input matrices (4-bit signed integers) were uniformly random, capturing realistic conditions and average-case power consumption. Instantaneous power was tracked separately for DAC, CAP, and COMP components throughout the entire 3,200 multiplications. For each multiplication, energy consumption per core for each component type was determined by integrating instantaneous power over the multiplication period (~393.86 μs). The total energy for each component type across 64 cores was divided by the multiplication duration to calculate average power per component type, which was then normalized per core by dividing by 64. The final reported averages, obtained from all 3,200 multiplications, represent realistic sustained-operation power consumption accounting for inter-core variations. The summarized results per core, shown in Tab. II, indicate the DAC consumes an average of 0.84 μW per core, the capacitor's power consumption is negligible at 2.4 pW per core, and the comparators dominate power consumption with an average of 4.02 μW per core, representing 82.7% of the total core power of 4.86 μW.

TABLE II
POWER AND AREA BREAKDOWN
OF A COMPUTING CORE

| | Power (nW) | Power (%) | Area (μm²) | Area (%) |
|---|---|---|---|---|
| DAC | 841.286 | 17.3045 | 1224.34 | 81.65 |
| CAP | 2.375 × 10⁻³ | 0.0001 | 213.23 | 14.22 |
| COMP | 4020.373 | 82.6954 | 61.93 | 4.13 |
| Total | 4861.662 | 100.0000 | 1499.50 | 100.00 |

TABLE III
WIRELIGHTNING CHIP CHARACTERISTICS
(40-NM TECHNOLOGY)

| Component | Parameter | Spec. | Power (mW) | Area (mm²) |
|---|---|---|---|---|
| Core | # per tile | 640 | 3.1115 | 0.9597 |
| Controller | # per tile | 10 | 49.4490 | 0.1688 |
| Reader | # per tile | 10 | 1.4860 | 0.0162 |
| Scheduler | # per tile | 1 | 102.4770 | 0.1709 |
| Tile | — | — | 156.5235 | 1.5740† |
| Total | # tiles | 8 | 1252.1880 | 12.8282† |

†Tile and overall areas include the area of inter-tile routing.

The power consumption of the digital modules (controller, reader, and scheduler) was extracted from Innovus power analysis results, following the completion of layout and routing. Each tile contains 640 analog computing cores along with its digital units: 10 controllers, 10 readers, and 1 scheduler. The total power consumption of a single tile is calculated by summing the power figures of these digital modules and the power dissipation of the 640 analog computing cores. As summarized in Tab. III, the full chip, composed of eight parallel tiles, consumes a total of 1252.1880 mW and occupies an area of 12.8282 mm², while each tile consumes 156.5235 mW and occupies 1.5740 mm².

Analog cores exhibit relatively low power consumption of 1.99%, achieved through simplified structures, passive energy-efficient components, and amplifier-free ADCs, despite their dominating footprint (60.97%) due to the quantity. Digital units contribute significantly more power, driven by controllers managing spike signals and register arrays, and schedulers handling extensive pipelines and intermediate storage. Readers, featuring simpler logic, minimally impact power and area.

### E. Chip Layout

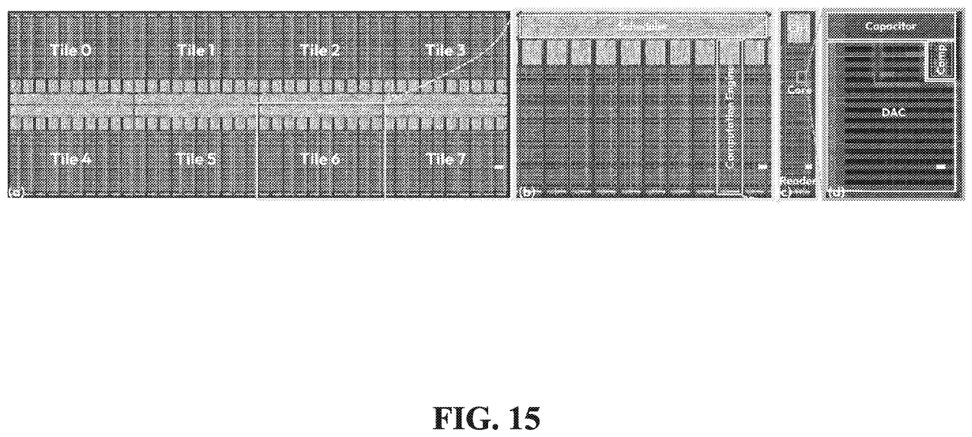

FIG. 15 shows chip layout at different hierarchical levels with parts (a), (b), (c), and (d). Part (a): Overall architecture (5920.31 μm×2166.81 μm; scale bar: 100 μm). Part (b): Tile (1469.08 μm×1071.40 μm; scale bar: 50 μm). Part (c): Computation engine (146.34 μm×929.06 μm; scale bar: 30 μm). Part (d): Computing core (45.22 μm×33.16 μm; scale bar: 2 μm). Part (a) of FIG. 15 illustrates the chip's overall layout architecture, comprising 8 tiles with a total size of 5920.31 μm 2166.81 μm. Part (b) of FIG. 15 presents an enlarged view of a tile's hierarchical structure, showing the digital scheduler (1454.93 μm×117.45 μm) and 10 computation engine modules arranged in parallel. Part (c) of FIG. 15 details the computation engine configuration, consisting of a controller module (117.45 μm×143.74 μm), an array of 64 analog computing cores (each 45.22 μm×33.16 μm), and a reader module (117.45 μm×13.78 μm). Part (d) of FIG. 15 further illustrates the micro-architecture of an analog computing core, consisting of a resistor-ladder-based DAC, a metal-insulator-metal capacitor utilizing four metal layers, and a comparator module composed of cascade inverters.

### F. Overall Evaluation

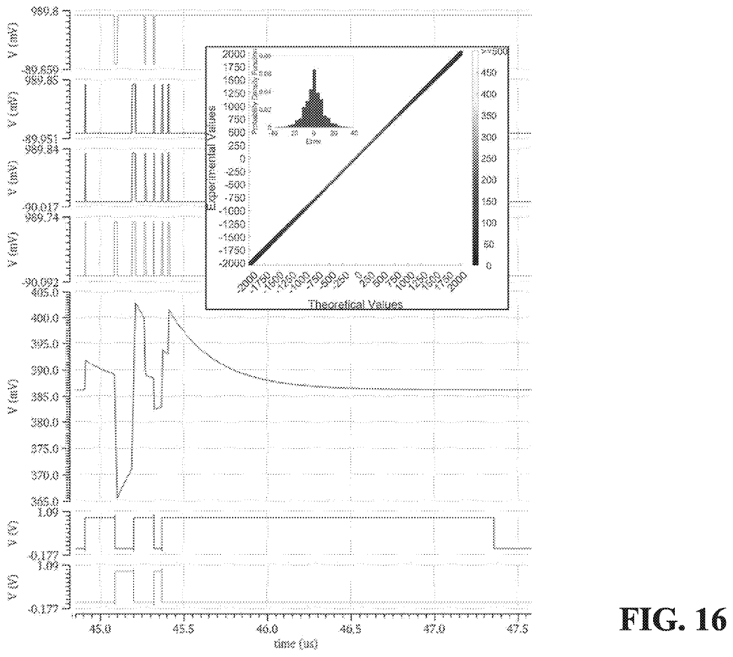

FIG. 16 shows single vector multiplication in the analog computing core (Cadence Spectre AMS simulation). Waveforms 1-4: Input spikes (I [symbol] 3:0 [symbol] ). Waveform 5: Capacitor voltage response. Waveforms 6-7: Greater-than and less-than comparator outputs. Inset: Frequency distribution (shading density) of results from 26.21 million vector multiplications (5120-dimensional, results ranging from −2047 to +2047). Inset's Inset: Probability density function depicting the error distribution between experimental and theoretical results.

The illustration of FIG. 16 demonstrates a single vector multiplication operation performed by an analog computing core, simulated using Cadence Spectre AMS mixed-signal simulation. Waveforms 1-4 depict input spike signals (I [symbol] 3:0 [symbol] ), waveform 5 shows the capacitor voltage response under spike excitation, and waveforms 6 and 7 display the outputs from the greater-than and less-than comparators, respectively. Waveform 5 exhibits the capacitor's discharge back to equilibrium, indicating a positive computation result. The final result is obtained by quantizing the high-level duration (in clock cycles) of the greater-than comparator's output. This quantized value is then used as the ROM address to retrieve the computation result. The inset in FIG. 16 summarizes statistical results from 26.21 million vector multiplications of 5120-dimensional vectors, each containing uniformly distributed 4-bit signed integers (from −7 to +7). The data distribution reveals an RMSE of 6.40 for the theoretical values within [−1023, +1023]. For the theoretical values extending to the entire range of [−2047, +2047], the RMSE rises to 9.27 (range-normalized RMSE of 0.23%). This trend aligns with the result sensitivity constraint, where the accuracy diminishes with increasing computation magnitude.

Table IV compares the PCB prototype and the ASIC simulation. The normalized error is defined as the 2-norm of the difference between experimental and theoretical results, normalized by the theoretical result's 2-norm. Range-normalized RMSE represents the root mean square error normalized by the output range. The PCB operates at 3.3 V (τ=55 μs), achieving a range-normalized RMSE of 1.80% and a normalized error of 9.18% within [−127, +127]. The 40-nm ASIC operates at 0.9 V (τ=256 ns), significantly improving accuracy (range-normalized RMSE: 0.23% and normalized error: 0.96%) within [−2047, +2047], due to higher clock frequency, lower comparator thresholds, and reduced noise. Both implementations validate capacitive computing principles and illustrate increased relative error with larger computation magnitudes, as described in Sec. IV-C. The ASIC's shorter τ enhances throughput by reducing spike generation and result decoding times (Eq. 3b, Eq. 8b). Overall, the comparison highlights WireLightning's scalability from a proof-of-concept to a high-performance integrated circuit solution.

TABLE IV
COMPARISON BETWEEN PCBPROTOTYPE
ANDASICSIMULATION

| Parameter | PCB | | ASIC | |
|---|---|---|---|---|
| Supply Voltage | 3.3 | V | 0.9 | V |
| Time Constant | 55 | μs | 256 | ns |

| | | |
|---|---|---|
| Input/Weight/Output Prec. | 4b/4b/8b | 4b/4b/12b |
| Output Range | [−127, +127] | [−2047, +2047] |
| Absolute RMSE | 4.58 | 9.27 |
| Range-norm. RMSE | 1.80% | 0.23% |
| Norm. Error | 9.18% | 0.96% |

| | | | | |
|---|---|---|---|---|
| Clock Frequency | 1 | MHz | 1 | GHz |

### G. Comparison

1) MVM Accuracy: The present computing paradigm mitigates the stochasticity and device-to-device variability inherent in analog programmable devices by encoding matrix B elements transiently into spike timing rather than in static device states. Matrix A elements are represented by spike amplitudes, with vector multiplication computation performed via the accumulation and decay of charges within capacitors. Although the present analog capacitive computing approach does not fully eliminate noise, it achieves significantly higher accuracy owing to its non-stochastic nature.

Table V compares the accuracy of the PCB prototype of the present invention against reported RRAM and PCM crossbar implementations. MVM accuracy is evaluated using two metrics: normalized error and range-normalized RMSE. Normalized error (Eq. 10) is defined as the 2-norm of the difference between experimental and theoretical results, normalized by the theoretical result's 2-norm. Range-normalized RMSE is computed by taking the root mean square of the error and then normalizing it by the output range. As shown in Table V, the normalized error of the present PCB prototype is 77.1% of that of a reported PCM crossbar implementation, and the range-normalized RMSE of the present PCB prototype is 69.2% of that of a reported RRAM crossbar implementation. These results highlight a significant error reduction, validating the robustness of the present capacitive computing approach, which avoids the conductivity drift or stochastic switching inherent in memristor- and PCM-based crossbar arrays.

error=yₑₓₚ−yₜₕₑₒ (10a)

norm.error=∥error∥₂/∥yₜₕₑₒ∥₂ (10b)

TABLE V
ACCURACY COMPARISON OF MATRIX
VECTOR MULTIPLICATION

| | Present | Reported PCM | Reported RRAM |
|---|---|---|---|
| | Prototype | Crossbar | Crossbar |
| Device | Capacitor | PCM | RRAM |
| Input/Weight/ | 4b/4b/8b | 8b/4b/8b | 6b/4b/8b |
| Output Prec. | | | |
| Input Data | purely uniform | sparse uniform | Training data |
| | random | random | |
| Weight Data | purely uniform | sparse uniform | Trained model |
| | random | random | |
| Output | [−127, +127] | [−100, +100] | [−10, +10] |
| Range | | | |
| RMSE | 4.58 | None | 0.519 |
| Range-norm. | 1.80% | None | 2.60% |
| RMSE | | | |
| Norm. Error | 9.18% | 11.9% | None |

2) ADC Power: ADCs significantly impact the overall power consumption of analog computing-in-memory architectures. Hence, minimizing ADC power usage is critical to improving the power efficiency of MVM operations. The present approach employs an op-amp-free ADC design based on time-domain conversion. This architecture utilizes a comparator module built by a cascaded inverter structure to transform analog capacitor voltages into digital-level signals, while a reader module measures the duration of these signals to complete the digital conversion. By eliminating operational amplifiers, the present architecture significantly reduces power consumption.

Table VI compares ADC power consumption during MVM operations. Implemented in a 40-nm CMOS process, comparator modules in the 64-core computing engine of the present invention consume a total power of 0.2573 mW, corresponding to approximately 0.0040 mW per core. The reader module, which processes digital signals across all 64 cores, consumes a total power of 0.1486 mW, corresponding to approximately 0.0023 mW per core. Accordingly, each ADC consumes approximately 0.0063 mW. As compared with reported ADC implementations including an 8-bit ADC in a 28-nm CMOS process and an 8-bit ADC in a 32-nm CMOS process, the present design achieves power reductions of 98.8% and 99.9%, respectively. These results demonstrate that the op-amp-free, time-domain ADC of the present invention improves power efficiency in analog computing-in-memory systems.

TABLE VI
ADC POWER COMPARISON OF MATRIX
VECTOR MULTIPLICATION

| | | Reported 28-nm | Reported 32-nm |
|---|---|---|---|
| | Present Design | ADC | ADC |
| CMOS Tech. | 40 nm | 28 nm | 32 nm |
| ADC Prec. | 12-bit | 8-bit | 8-bit |
| Spec. | 64 COMPs & 1 | 64 ADCs, 0.97 | 1 ADC, 326.4 |
| | Reader, 0.4059 mW | nJ/30 ns | pJ/50 ns |
| Single ADC | 0.0063 | 0.5052 | 6.5280 |
| Power (mW) | | | |

3) Throughput: The present architecture employs a single capacitor for vector multiplication and is arranged in tiles of 640 capacitors for highly parallel processing. Analog-to-digital conversion of computational outputs occurs simultaneously with capacitor voltage decay. Exploiting value repetition, row-wise parallel computations, and a four-stage pipeline simplifies and scales matrix multiplication. These methods significantly improve throughput. Regarding power efficiency, in contrast to memristive and PCM-based architectures that rely on energy-consuming current summation for addition, the present architecture achieves addition via charge accumulation, eliminating both current summation and the associated IR drop issues. Additionally, the implementation of narrow-voltage-spike signals for charge control and the unique op-amp-free, time-domain ADC further enhance power efficiency.

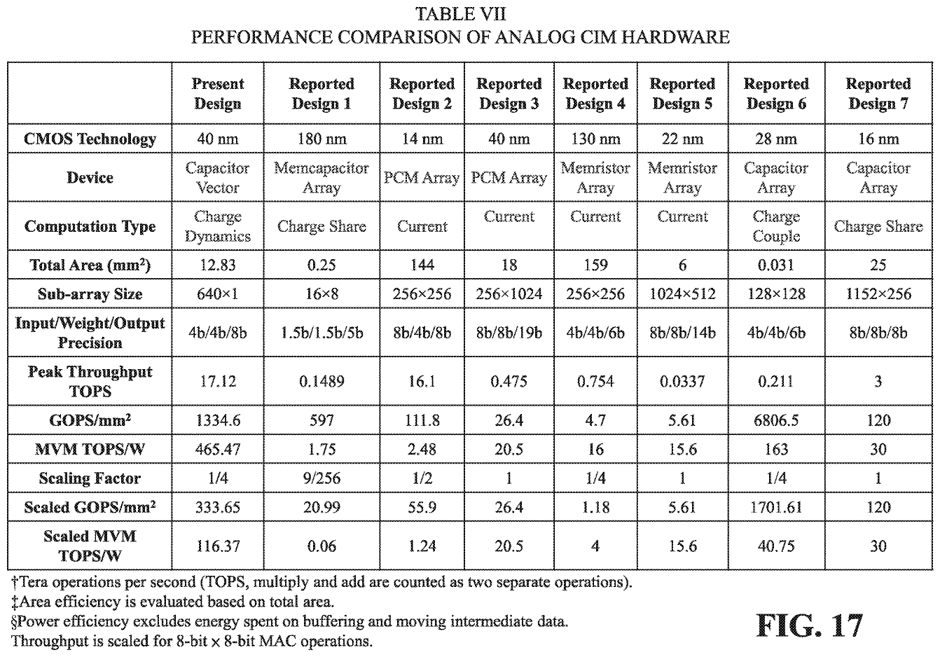

In FIG. 17, Table VII compares the architecture of the present invention with state-of-the-art (SOTA) designs in throughput, area efficiency, and power efficiency. For throughput, the multiplication of two 5120×5120 matrices (~0.2684 tera-operations) is achieved with a latency of 15.68 ms (Sec. VI-C), yielding a raw through-put of 17.12 tera-operations per second (TOPS). Regarding power efficiency, considering only MVM operational power (3.1115×8 mW consumed in computing cores and 1.4860×8 mW in reader modules), the present architecture achieves a raw power efficiency of 465.47 TOPS/W at 4-bit precision, with 0.9-V power supply in a 40-nm CMOS process. In alignment with previous work in this field, this evaluation excludes the energy overhead associated with buffering and moving intermediate data. To fairly compare architectures with different precisions, all throughput figures are normalized to 8-bit arithmetic operations. The scaled power efficiency of the present architecture shows a 2.9-fold improvement over the SOTA analog computing-in-memory accelerator. The substantial power efficiency gains of the present architecture are driven by three innovations: narrow-voltage-spike signal representation, analog computation based on charge accumulation and decay, and the op-amp-free, time-domain ADC design.

### VII: CONCLUSION

The present disclosure introduces a capacitive computing architecture designed for energy-efficient matrix multiplication by exploiting the intrinsic charge dynamics of capacitors. Matrix elements are encoded into spike amplitudes and timings, enabling analog dot-product computation directly through capacitor charging and discharging behaviors. Key innovations include an amplitude-timing dual-encoding scheme enabling constant-time analog dot-product computations, a capacitor decay-based decoding strategy that reduces dependency on power-intensive ADCs, row-parallel computations enabling simultaneous dot-product calculations across multiple rows to maximize throughput, and a multiplication simplification scheme that exploits value repetition in low-bit quantized vectors to reduce multiplications to constant time complexity. Furthermore, critical constraints on the present MVM computing paradigm are addressed. PCB-level experiments achieved a range-normalized RMSE of 1.80% (69.2% of the error in SOTA RRAM crossbar implementations) and a normalized error of 9.18% (77.1% of that in leading PCM crossbar solutions). Additionally, chip-level simulations reported a low range-normalized RMSE of 0.23% over extensive vector multiplications. A 5120× 5120 matrix multiplication was executed in 15.68 ms, achieving 465.47 TOPS/W power efficiency at 4-bit arithmetic operations with 40-nm CMOS technology. Compared to existing accelerators, such as those based on memristive, memcapacitive, and PCM, the present architecture exhibits a 2.9-fold improvement in power-efficiency, driven by narrow-voltage spikes, analog computation based on charge accumulation and decay, and op-amp-free ADC design via time-domain conversion. This work highlights capacitive computing as a promising low-power and scalable approach for neuromorphic and edge AI systems, establishing a foundation for future development.

The foregoing description primarily sets forth theoretical principles, computational mechanisms, and performance characteristics associated with capacitance-based matrix multiplication. Based on such principles and mechanisms, the present invention further provides physical circuit structures, hardware components, and coordinated system architectures for implementing the disclosed matrix multiplication operations. In particular, the following description introduces hardware-level configurations by which the foregoing computational principles are embodied in interconnected functional units and physical computing structures.

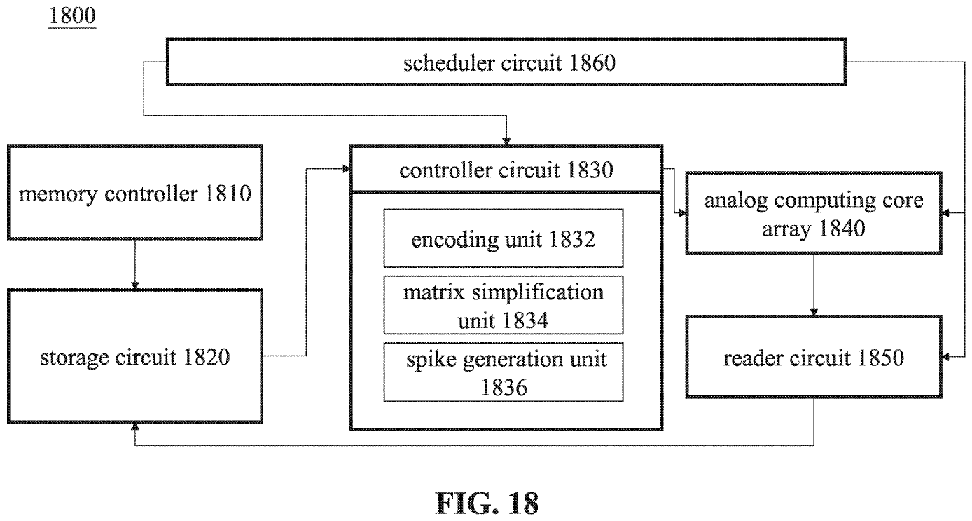

FIG. 18 shows a block diagram of a capacitance-based matrix multiplication system 1800 according to some embodiments of the present invention. The capacitance-based matrix multiplication system 1800 may include a memory controller 1810, a storage circuit 1820, a controller circuit 1830, an analog computing core array 1840, a reader circuit 1850, and a scheduler circuit 1860. The foregoing components may be connected or coupled to one another so as to transmit signals, exchange data, and coordinate operations thereamong. The capacitance-based matrix multiplication system 1800 may be configured to perform matrix multiplication through charge accumulation and discharge behavior of one or more capacitors in the analog computing core array 1840, thereby providing a hardware-based computation architecture for artificial intelligence applications.

The memory controller 1810 may be configured to transfer matrix data to and from the storage circuit 1820. The memory controller 1810 may further manage data movement between the capacitance-based matrix multiplication system 1800 and one or more external memory resources. In some embodiments, the memory controller 1810 may control loading of matrix data into the storage circuit 1820 and output of computation results from the storage circuit 1820. In some embodiments, the memory controller 1810 may correspond to the memory controller shown in FIG. 6. The memory controller 1810 may be implemented by dedicated control logic, interface circuitry, one or more bus controllers, and/or other data-transfer circuitry configured to support movement of matrix data and computation results.

The storage circuit 1820 may be configured to store matrix data, intermediate data, and/or computation results used by the capacitance-based matrix multiplication system 1800. The storage circuit 1820 may provide stored matrix data to the controller circuit 1830 for generation of analog spike signals and may receive digital results from the reader circuit 1850 after completion of capacitance-based computation. In some embodiments, the storage circuit 1820 may include one or more on-chip memory resources, buffer circuits, register resources, SRAM resources, and/or other data storage circuitry. In some embodiments, the storage circuit 1820 may correspond to one or more storage resources associated with the scheduler and related system components shown in FIG. 6.

The controller circuit 1830 may be configured to obtain matrix data from the storage circuit 1820 and to generate analog spike signals based on the matrix data. The analog computing core array 1840 may be configured to receive the analog spike signals from the controller circuit 1830 and to generate analog computation results corresponding to dot product operations. The reader circuit 1850 may be configured to receive signals from the analog computing core array 1840 and to determine digital results of the dot product operations. The scheduler circuit 1860 may be configured to coordinate data transfers and timing control among the controller circuit 1830, the analog computing core array 1840, and the reader circuit 1850, and the digital results determined by the reader circuit 1850 may be stored in the storage circuit 1820. This arrangement corresponds to the system-level relationship recited for the controller, the plurality of analog computing cores, the reader, and the scheduler in an aspect of the present invention.

The following paragraphs further describe functions and example implementations of the controller circuit 1830, the analog computing core array 1840, the reader circuit 1850, and the scheduler circuit 1860. In some embodiments, these components may correspond to related system-level functional structures shown in FIG. 6.

The controller circuit 1830 may include an encoding unit 1832, a matrix simplification unit 1834, and a spike generation unit 1836. The matrix simplification unit 1834 may be configured to identify repeated absolute values in a quantized column vector, group corresponding matrix elements, and pre-accumulate grouped values so as to reduce a number of multiplication operations. The encoding unit 1832 may be configured to apply an amplitude encoding scheme to matrix data, in which spike amplitudes correspond to matrix row elements; spike timings may be determined by the scheduler circuit 1860 based on matrix column elements. The spike generation unit 1836 may be configured to generate the analog spike signals based on outputs of the encoding unit 1832 and the matrix simplification unit 1834, and to provide the analog spike signals to the analog computing core array 1840. In some embodiments, the controller circuit 1830 may correspond to the controller shown in FIG. 6, and the encoding unit 1832, the matrix simplification unit 1834, and the spike generation unit 1836 may correspond to functional portions implemented by the controller modules and associated subcomponents shown in FIG. 6, including portions corresponding to arithmetic processing, data storage, and temporary spike-value holding.

The analog computing core array 1840 may include a plurality of analog computing cores arranged in a row-wise parallel architecture. Each analog computing core may be configured to compute a dot product between one matrix row and a column vector concurrently and independently relative to other analog computing cores. In some embodiments, the analog computing core array 1840 may correspond to the multiple cores shown in FIG. 6 within one or more computation engines, and each analog computing core included in the analog computing core array 1840 may further include a digital-to-analog conversion circuit, a capacitor, and a comparator circuit, for example as further illustrated in FIG. 7. The digital-to-analog conversion circuit may be configured to convert the analog spike signals into voltage pulses, the capacitor may be configured to accumulate and discharge charge in response to the voltage pulses so as to generate a time-varying voltage corresponding to an analog dot product result, and the comparator circuit may be configured to detect a deviation of the time-varying voltage from an equilibrium level.

The reader circuit 1850 may be electrically coupled to the analog computing core array 1840 and may be configured to determine a digital result of each dot product operation by measuring a time interval associated with return of the time-varying voltage to the equilibrium level and converting the time interval into a quantized value using a time-based decoding scheme. In some embodiments, the reader circuit 1850 may receive output signals from comparator circuits respectively included in the analog computing cores of the analog computing core array 1840. In some embodiments, the reader circuit 1850 may correspond to the reader module shown in FIG. 6 and may include functionality corresponding to sign checking and result collection as further described with reference to the reader of FIG. 6. Thus, the reader circuit 1850 may determine whether a corresponding computation result is positive or negative and may store or output a corresponding decoded result.

The scheduler circuit 1860 may be configured to provide scheduling signals, control signals, address signals, and/or timing coordination signals to the controller circuit 1830, the analog computing core array 1840, and the reader circuit 1850. In some embodiments, the scheduler circuit 1860 may correspond to the scheduler shown in FIG. 6 and may include, or may cooperate with, control logic and storage resources for scheduling matrix-vector multiplication operations, such as memory resources corresponding to SRAM, spike ROM, positive-result ROM, and negative-result ROM shown in FIG. 6. Additionally, the scheduler circuit 1860 may also obtain matrix B data from the storage circuit 1820 for generating timing control signals. The storage circuit 1820 may correspond to a data storage resource for temporarily storing matrix data and/or computation results, and in some embodiments may correspond to on-chip memory resources associated with the scheduler and/or other system components shown in FIG. 6. The memory controller 1810 may correspond to the memory controller shown in FIG. 6 and may be configured to manage transfer of data between the storage circuit 1820 and an external memory. Accordingly, FIG. 18 provides a system-level representation of the architecture shown in FIG. 6, while specific module implementations and additional sub-features shown in FIG. 6 may be selectively incorporated into the system 1800 in some embodiments.

Through cooperation among the memory controller 1810, the storage circuit 1820, the controller circuit 1830, the analog computing core array 1840, the reader circuit 1850, and the scheduler circuit 1860, the capacitance-based matrix multiplication system 1800 may provide a hardware architecture for receiving matrix data, generating analog spike signals, performing row-wise parallel capacitance-based computation, decoding analog computation results, and storing digital results. By distributing such functions among coordinated system-level components, the capacitance-based matrix multiplication system 1800 may support efficient matrix multiplication while reducing dependence on conventional current-summation-based architectures and power-intensive analog-to-digital conversion arrangements. Accordingly, the capacitance-based matrix multiplication system 1800 may provide a physically implemented computation architecture suitable for artificial intelligence acceleration.

While FIG. 18 illustrates a system-level arrangement of components for implementing capacitance-based matrix multiplication, additional details of computation at an individual analog computing core may be further described with reference to a core-level architecture. The following description turns to a circuit-level configuration corresponding to an analog computing core included in the analog computing core array 1840, so as to further explain how analog spike signals are converted into voltage-based dot product computation results and how such results are detected and decoded.

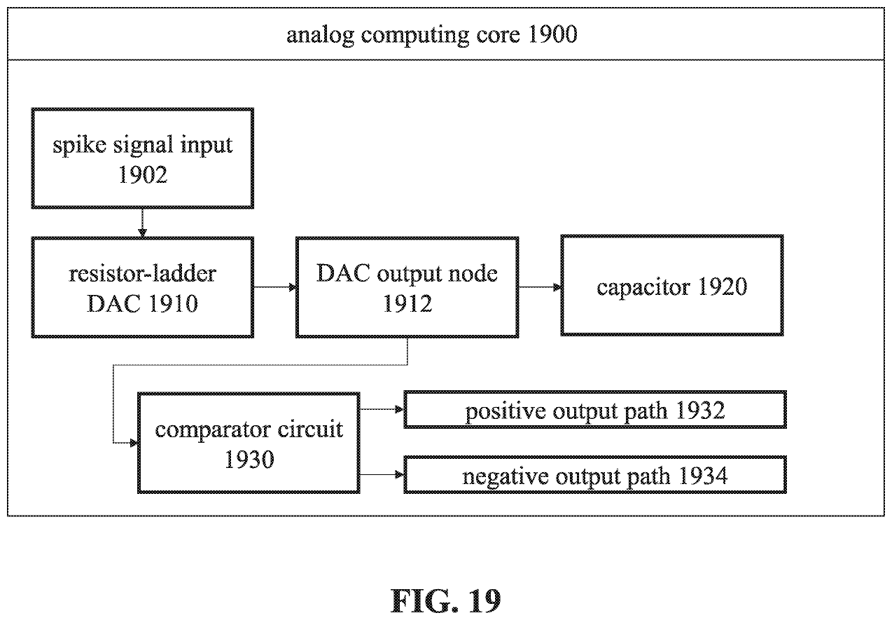

FIG. 19 shows a block diagram of an analog computing core 1900 according to some embodiments of the present invention. The analog computing core 1900 may include an spike signal input 1902, a resistor-ladder DAC 1910, a DAC output node 1912, a capacitor 1920, a comparator circuit 1930, a positive output path 1932, and a negative output path 1934. The foregoing components may be connected or coupled to one another so as to transmit signals and support capacitance-based dot product computation. In some embodiments, the analog computing core 1900 shown in FIG. 19 may correspond to a circuit-level representation of an analog computing core included in the analog computing core array 1840 of FIG. 18 and may further correspond to related circuit structures shown in FIG. 7.

The spike signal input 1902 may be configured to receive spiking signals for capacitance-based computation. In some embodiments, the signals received at the spike signal input 1902 are triggered by the controller circuit 1830 described with reference to FIG. 18. The analog spike signals may encode matrix-related information in accordance with an amplitude-temporal encoding scheme and may be provided to the resistor-ladder DAC 1910 for subsequent generation of voltage signals used in dot product operations.

The resistor-ladder DAC 1910 may be configured to convert the digital spike signals into analog voltage signals for capacitance-based computation. In some embodiments, the resistor-ladder DAC 1910 may include a passive resistor network configured to generate a plurality of voltage levels corresponding to different spike amplitudes. The resistor-ladder DAC 1910 may provide an output signal to the DAC output node 1912, and the DAC output node 1912 may provide a voltage node through which a computation-related signal is supplied to the capacitor 1920 and monitored by the comparator circuit 1930.

The capacitor 1920 may be electrically coupled to the DAC output node 1912 and may be configured to accumulate and discharge charge in response to voltage signals generated by the resistor-ladder DAC 1910. Through such charging and discharging behavior, the capacitor 1920 may generate a time-varying voltage corresponding to an analog result of a dot product operation. In some embodiments, the capacitor 1920 may correspond to a computing capacitor for implementing capacitance-based multiplication and accumulation behavior. Accordingly, the capacitor 1920 may provide a physical computation element by which analog spike signals are translated into capacitance-based dot product results.

The comparator circuit 1930 may be electrically coupled to the DAC output node 1912 and may be configured to monitor a voltage associated with the capacitor 1920. The comparator circuit 1930 may detect a deviation of the monitored voltage from an equilibrium level and may generate one or more output signals indicating return behavior of the monitored voltage toward the equilibrium level. In some embodiments, the comparator circuit 1930 may correspond to a circuit structure for detecting a time interval associated with convergence of the time-varying voltage generated by the capacitor 1920. Thus, the comparator circuit 1930 may cooperate with the capacitor 1920 to convert an analog dot product result into a form suitable for time-based decoding.

The positive output path 1932 and the negative output path 1934 may be configured to output signals corresponding to different voltage conditions detected by the comparator circuit 1930. In some embodiments, the positive output path 1932 may be associated with a condition in which the monitored voltage is above an equilibrium level, and the negative output path 1934 may be associated with a condition in which the monitored voltage is below the equilibrium level. The positive output path 1932 and the negative output path 1934 may therefore provide output signals from which sign-related information and time-interval-related information of the dot product operation may be derived. In some embodiments, the output signals of the positive output path 1932 and the negative output path 1934 may be provided to the reader circuit 1850 of FIG. 18 for determination of a digital computation result.

The resistor-ladder DAC 1910, the DAC output node 1912, the capacitor 1920, the comparator circuit 1930, the positive output path 1932, and the negative output path 1934 may cooperate to implement capacitance-based dot product computation within the analog computing core 1900. More specifically, the resistor-ladder DAC 1910 may convert received analog spike signals into voltage signals, the capacitor 1920 may generate a time-varying voltage through charge accumulation and discharge behavior, and the comparator circuit 1930 may detect return behavior of the time-varying voltage and may generate output signals on the positive output path 1932 and the negative output path 1934. Through such cooperation, the analog computing core 1900 may provide a circuit-level structure for implementing analog computation and result signaling in the capacitance-based matrix multiplication system 1800.

In some embodiments, the resistor-ladder DAC 1910 may include a passive resistor network having a plurality of resistor elements arranged in a ladder configuration. For example, the passive resistor network may include first resistor elements having a first resistance value and second resistor elements having a second resistance value greater than the first resistance value, such as a repeated R and 2R relationship. The resistor-ladder DAC 1910 may further include a plurality of digital input terminals corresponding to respective bits of an input signal, and the passive resistor network may divide a supply voltage into a plurality of discrete voltage levels according to states of the digital input terminals. In this manner, the resistor-ladder DAC 1910 may generate voltage signals of different amplitudes for capacitance-based computation.

In some embodiments, the DAC output node 1912 may correspond to an internal computation node at which an output of the resistor-ladder DAC 1910 is provided and from which a computation-related voltage is supplied to the capacitor 1920 and the comparator circuit 1930. The capacitor 1920 may be coupled between the DAC output node 1912 and a reference node, such as a lower supply node or ground node. For example, the capacitor 1920 may be implemented as a grounded capacitor coupled to a reference potential corresponding to VSS. Through such arrangement, the capacitor 1920 may accumulate charge when the resistor-ladder DAC 1910 drives the DAC output node 1912 toward a first voltage range and may discharge when the DAC output node 1912 returns toward an equilibrium level, thereby generating a time-varying voltage suitable for dot product computation.

In some embodiments, the comparator circuit 1930 may include one or more inverter-based comparison stages coupled to supply nodes, such as an upper supply node corresponding to VDD and a lower supply node corresponding to VSS. The comparator circuit 1930 may receive a voltage associated with the DAC output node 1912 and/or the capacitor 1920 and may compare the received voltage with an equilibrium level. The positive output path 1932 may include a first inverter-based path associated with a voltage-above-equilibrium condition, and the negative output path 1934 may include a second inverter-based path associated with a voltage-below-equilibrium condition. In some embodiments, the positive output path 1932 may include an even number of inverter stages, and the negative output path 1934 may include an odd number of inverter stages.

In some embodiments, when the voltage at the DAC output node 1912 is driven above the equilibrium level, the capacitor 1920 may be charged and the comparator circuit 1930 may cause the positive output path 1932 to output a corresponding signal. When the voltage at the DAC output node 1912 is driven below the equilibrium level, the capacitor 1920 may be discharged and the comparator circuit 1930 may cause the negative output path 1934 to output a corresponding signal. Duration and/or sequence of signals output through the positive output path 1932 and the negative output path 1934 may be used for determining sign-related information and magnitude-related information of a dot product result.

In some embodiments, the resistor-ladder DAC 1910, the DAC output node 1912, the capacitor 1920, and the comparator circuit 1930 may be arranged such that analog-to-digital conversion is integrated with return of a computation-related voltage toward an equilibrium level. Accordingly, the analog computing core 1900 may provide a circuit configuration in which voltage generation, capacitive computation, and result signaling are performed in a coordinated manner without reliance on a separate high-power analog-to-digital conversion block.

In operation, matrix data associated with matrix A and matrix B may be transferred by the memory controller 1810 and stored in the storage circuit 1820 for in-transit massively parallel matrix multiplication. In some embodiments, matrix A and matrix B may each be represented by 4-bit signed data. The controller circuit 1830 may obtain matrix A data from the storage circuit 1820 and may process the matrix data through the matrix simplification unit 1834, the encoding unit 1832, and the spike generation unit 1836, while the scheduler circuit 1860 may also obtain matrix B data from the storage circuit 1820 for generating timing control signals. More specifically, the matrix simplification unit 1834 may identify repeated absolute values in a quantized column vector of matrix B, group corresponding matrix elements in matrix A, and pre-accumulate grouped values so as to reduce a number of multiplication operations to a constant count. The encoding unit 1832 may apply an amplitude encoding scheme to matrix data, in which spike amplitudes correspond to matrix A row elements; spike timings may be determined by the scheduler circuit 1860 based on matrix B column elements. Based on such processing, the spike generation unit 1836 may generate a sequence of analog spike signals and may provide the analog spike signals to respective analog computing cores of the analog computing core array 1840 arranged in a row-wise parallel architecture.

Within each analog computing core 1900, input signals may be received at the spike signal input 1902 and supplied to the resistor-ladder DAC 1910. In some embodiments, the input signals may include 4-bit signed digital inputs corresponding to matrix A row elements and associated with analog spike generation.

The resistor-ladder DAC 1910 may be implemented as an R-2R ladder DAC comprising a passive resistor network configured to divide a reference voltage into a plurality of discrete voltage levels selectable by digital input signals. Based on the received input signals, the resistor-ladder DAC 1910 may generate an analog spike signal having an amplitude corresponding to one of the discrete voltage levels and may provide a corresponding voltage signal to the DAC output node 1912. The capacitor 1920, also referred to as CAP, may be electrically coupled to the DAC output node 1912 and may accumulate and discharge charge in response to the voltage signal so as to generate a time-varying voltage corresponding to an analog result of a dot product operation. In some embodiments, the time-varying voltage may return toward an equilibrium voltage level corresponding to V_{DD}/2, whereby rapid charging behavior above V_{DD}/2 and rapid discharging behavior below V_{DD}/2 may be used for capacitance-based computation, and the capacitor 1920 may serve as a primary component for vector multiplication.

The comparator circuit 1930, also referred to as COMP, may be electrically coupled to the capacitor 1920 and/or the DAC output node 1912 and may monitor a voltage associated with the capacitor 1920. Since an input of the comparator circuit 1930 may be directly connected to transistor gates, the resistor-ladder DAC 1910 may exclusively control charge injection and charge release of the capacitor 1920, thereby minimizing charge leakage and preserving computational accuracy and signal integrity. The comparator circuit 1930 may detect a deviation of the monitored voltage from the equilibrium voltage level and may generate a signal indicating a time interval required for the monitored voltage to return toward the equilibrium voltage level. In some embodiments, the comparator circuit 1930 may include a positive output path 1932, for example a greater-than output path, corresponding to OUTP and containing an even number of inverters, and a negative output path 1934, for example a less-than output path, corresponding to OUTN and containing an odd number of inverters. The positive output path 1932 may output a logical 1 when the monitored voltage is above the equilibrium voltage level, and the negative output path 1934 may output a logical 1 when the monitored voltage is below the equilibrium voltage level. Sequence and duration of signals appearing on OUTP and OUTN may therefore indicate sign-related information and magnitude-related information of the dot product operation. The reader circuit 1850 may receive signals from comparator circuits respectively included in the analog computing cores of the analog computing core array 1840 and may determine a digital result by measuring the time interval and converting the time interval into a quantized value using a time-based decoding scheme, wherein the decoding is based on the number of clock cycles elapsed during convergence of the capacitor voltage to the equilibrium voltage level. The scheduler circuit 1860 may coordinate data transfers and timing control among the controller circuit 1830, the analog computing core array 1840, and the reader circuit 1850 during matrix-vector multiplication.

The digital result determined by the reader circuit 1850 may be stored in the storage circuit 1820, for example in an output register corresponding to a dot product result. In some embodiments, digital results generated from a plurality of analog computing cores may collectively form a result vector or another matrix multiplication output corresponding to matrix multiplication of matrix A and matrix B. Such result vector or matrix multiplication output may be transferred through the memory controller 1810, output to another processing resource, and/or provided as an input to a subsequent stage of a neural network model for performing an artificial intelligence inference task. Accordingly, the capacitance-based matrix multiplication system 1800 and the analog computing core 1900 may cooperate to provide an end-to-end hardware architecture that supports matrix data loading, signal generation, row-wise parallel capacitance-based dot product computation, result decoding, result storage, and subsequent result utilization. By integrating analog-to-digital conversion within the capacitor reset process, this architecture may reduce or remove dependence on traditional high-power, large-area ADCs, thereby enhancing overall scalability.

In view of the foregoing, the present invention provides WireLightning, a capacitance-based matrix multiplication architecture including corresponding circuits, systems, and methods for performing in-transit massively parallel matrix multiplication. The present invention exploits intrinsic charge accumulation and discharge behavior of passive capacitors to implement dot-product computation, and applies an amplitude-temporal dual encoding scheme in which matrix elements are represented by spike amplitudes and spike timings. The present invention further employs a time-based decoding scheme for converting analog computation results into digital results, and a row-wise parallel architecture for concurrently processing multiple matrix rows.

Compared with conventional analog and digital matrix-multiplication approaches, the present invention addresses multiple limitations associated with weight drift, stochasticity, IR drop, peripheral overhead, and power-intensive analog-to-digital conversion. By representing matrix-related data through transient spike encoding rather than persistent programmable device states, the present invention reduces susceptibility to device non-idealities. By performing accumulation through capacitive charge behavior rather than current summation along shared interconnects, the present invention mitigates limitations associated with high current summation and IR drop. In addition, by exploiting repeated values in low-bit quantized vectors, the present invention reduces multiplication complexity to a constant count and improves computational efficiency.

Experimental and simulation results demonstrate that the present invention provides high accuracy and high power efficiency. PCB-level experiments achieve a range-normalized RMSE of 1.80% and a normalized error of 9.18%, corresponding to 69.2% and 77.1% of errors reported for comparable RRAM- and PCM-based crossbar implementations, respectively. Chip-level simulations further achieve a range-normalized RMSE of 0.23%. For matrix multiplication of two 5120×5120 matrices, the disclosed architecture achieves 465.47 TOPS/W at 4-bit precision in a 40-nm CMOS technology, with a 2.9-fold improvement in scaled power efficiency over a state-of-the-art analog computing-in-memory accelerator.

Accordingly, the present invention provides a practically implementable and scalable hardware architecture for artificial intelligence acceleration. By combining passive capacitive computation, time-domain result decoding, row-wise parallel processing, and multiplication simplification based on repeated quantized values, the present invention supports efficient matrix multiplication with reduced dependence on traditional high-power, large-area ADC structures. The disclosed architecture therefore provides a hardware-based approach suitable for neuromorphic computing, edge artificial intelligence systems, and other applications involving large-scale matrix operations.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An analog computing core for capacitance-based dot product computation, comprising:
a digital-to-analog conversion circuit configured to receive input signals associated with spike generation and to generate a voltage signal;
a capacitor electrically coupled to the digital-to-analog conversion circuit and configured to accumulate and discharge charge in response to the voltage signal so as to generate a time-varying voltage corresponding to a dot product operation; and
a comparator circuit electrically coupled to the capacitor and configured to monitor the time-varying voltage and to generate one or more output signals indicative of a time interval associated with return of the time-varying voltage toward an equilibrium level.

2. The analog computing core of claim 1, wherein the digital-to-analog conversion circuit comprises a resistor-ladder digital-to-analog converter.

3. The analog computing core of claim 2, wherein the resistor-ladder digital-to-analog converter comprises an R-2R ladder DAC including a passive resistor network configured to divide a reference voltage into a plurality of discrete voltage levels selectable by digital input signals.

4. The analog computing core of claim 3, wherein the resistor-ladder digital-to-analog converter is configured to receive a 4-bit signed digital input corresponding to a matrix element and to output a spike signal having an amplitude corresponding to one of the discrete voltage levels.

5. The analog computing core of claim 1, further comprising a DAC output node electrically coupling the digital-to-analog conversion circuit to the capacitor and the comparator circuit, wherein an input of the comparator circuit is directly connected to transistor gates such that the digital-to-analog conversion circuit exclusively controls charge injection and charge release of the capacitor, thereby minimizing charge leakage.

6. The analog computing core of claim 1, wherein the comparator circuit comprises a positive output path corresponding to OUTP containing an even number of inverters, and a negative output path corresponding to OUTN containing an odd number of inverters, wherein the positive output path is configured to output a high-level signal when the time-varying voltage is above the equilibrium level, and wherein the negative output path is configured to output a high-level signal when the time-varying voltage is below the equilibrium level.

7. The analog computing core of claim 6, wherein the comparator circuit is configured such that sequence and duration of signals on OUTP and OUTN indicate sign-related information and magnitude-related information of a digital result corresponding to the dot product operation, and wherein the equilibrium level corresponds to half of a supply voltage, V_{DD}/2.

8. A system for in-transit massively parallel matrix multiplication via capacitance-based computation, comprising:
a storage circuit configured to store matrix data associated with a first matrix and a second matrix;
a controller circuit configured to obtain data of the first matrix from the storage circuit and to generate spike signals according to an amplitude encoding scheme in which spike amplitudes correspond to matrix elements of the first matrix;
an analog computing core array including a plurality of analog computing cores according to claim 1, the plurality of analog computing cores being arranged in a row-wise parallel architecture and each being configured to receive the spike signals and generate a time-varying voltage corresponding to a dot product operation between at least part of the first matrix and at least part of the second matrix;
a reader circuit configured to determine a digital result of the dot product operation based on a time interval associated with return of the time-varying voltage toward an equilibrium level; and
a scheduler circuit configured to coordinate timing and data transfer among the controller circuit, the analog computing core array, and the reader circuit, wherein the scheduler circuit determines spike timings based on matrix elements of the second matrix, and wherein the digital result is storable in the storage circuit as at least part of a matrix multiplication output.

9. The system of claim 8, wherein the controller circuit comprises:
an encoding unit configured to apply the amplitude encoding scheme to the data of the first matrix;
a matrix simplification unit configured to identify repeated absolute values in a quantized column vector of the second matrix, group corresponding matrix elements in the first matrix, and pre-accumulate grouped values so as to reduce a number of multiplication operations; and
a spike generation unit configured to generate the spike signals based on outputs of the encoding unit and the matrix simplification unit.

10. The system of claim 9, wherein the encoding scheme is an amplitude-temporal dual encoding scheme.

11. The system of claim 8, wherein the reader circuit is configured to determine the digital result by measuring the time interval and converting the time interval into a quantized value using a time-based decoding scheme.

12. The system of claim 11, wherein the time-based decoding scheme is based on a number of clock cycles elapsed during convergence of the time-varying voltage to the equilibrium level.

13. The system of claim 8, wherein the storage circuit comprises an output register configured to store the digital result corresponding to the dot product operation.

14. The system of claim 8, wherein digital results generated from the plurality of analog computing cores collectively form a result vector corresponding to matrix multiplication of the first matrix and the second matrix.

15. The system of claim 14, wherein the result vector is provided as an input to a subsequent stage of a neural network model for performing an artificial intelligence inference task.

16. A method for in-transit massively parallel matrix multiplication via capacitance-based computation, comprising:
obtaining matrix data associated with a first matrix and a second matrix;
generating spike signals based on the matrix data according to an encoding scheme in which spike amplitudes correspond to matrix elements of the first matrix and spike timings correspond to matrix elements of the second matrix;
providing the spike signals to a plurality of analog computing cores arranged in a row-wise parallel architecture;
in each of the analog computing cores, generating a time-varying voltage by accumulating and discharging charge in a capacitor in response to the spike signals so as to perform a dot product operation;
detecting, by a comparator circuit, a time interval associated with return of the time-varying voltage toward an equilibrium level; and
determining a digital result of the dot product operation based on the time interval.

17. The method of claim 16, further comprising:
prior to generating the spike signals, identifying repeated absolute values in a quantized column vector of the second matrix;
grouping corresponding matrix elements in the first matrix; and
pre-accumulating grouped values so as to reduce a number of multiplication operations.

18. The method of claim 16, wherein generating the spike signals comprises applying an amplitude-temporal dual encoding scheme to the matrix data.

19. The method of claim 16, further comprising converting the time interval into a quantized value using a time-based decoding scheme, wherein the time-based decoding scheme is based on a number of clock cycles elapsed during convergence of the time-varying voltage to the equilibrium level.

20. The method of claim 16, further comprising:
storing the digital result in an output register corresponding to a dot product result; and
forming, from digital results generated by the plurality of analog computing cores, a result vector corresponding to matrix multiplication of the first matrix and the second matrix,
wherein the result vector is provided as an input to a subsequent stage of a neural network model for performing an artificial intelligence inference task.
